(19) United States
(12) Patent Application Publication
(10) Pub. No.: US 2007/0185817 A1
(43) Pub. Date: Aug. 9, 2007

(54) APPARATUS FOR FACILITATING THE SALE, TRANSFER, AND/OR ASSIGNMENT OF INTELLECTUAL PROPERTY

(76) Inventor: HEATHER ALISHA DAVIS, WARREN, OH (US)

Correspondence Address: BROUSE MCDOWELL LPA, 388 SOUTH MAIN STREET, SUITE 500, AKRON, OH, 44311, US

(21) Appl. No.: 11/625,635

(22) Filed: Jan. 22, 2007

Related U.S. Application Data
(60) Provisional application No. 60/760,416, filed on Jan. 20, 2006.
(60) Provisional application No. 60/760,417, filed on Jan. 20, 2006.

(51) Int. Cl. G06Q 99/00

(52) U.S. Cl. 705/51

(57) ABSTRACT

A new and improved apparatus for facilitating the sale, transfer, and/or assignment of intellectual property is herein disclosed.

This application claims priority to a provisional patent application Ser. No. 60/760,416, filed Jan. 20, 2006, entitled THE INTELLECTUAL PROPERTY EXCHANGE and Ser. No. 60/760,417, filed Jan. 20, 2006, entitled THE INTELLECTUAL PROPERTY SEARCH ENGINE. This invention relates to the field of property transfers and auctions, and more particularly to the transfer and auction of intellectual property, and even more particularly to a real property location for facilitating the sale, transfer, and/or assignment of intellectual property.

### I. BACKGROUND OF THE INVENTION

### A. Field of the Invention

B. Description of the Related Art

It is known in the art to provide online databases of patents, trademarks, and copyrights. These databases can be searched using various search criteria, and include text searching.

The present invention provides a new and improved method for facilitating the sale, transfer, and/or assignment of intellectual property, and overcomes certain difficulties inherent in the related inventions while providing better overall results.

### II. SUMMARY OF THE INVENTION

In accordance with one aspect of the present invention, a method for effecting exchange of intellectual property rights, which may be embodied in a global computer network, includes all types of intellectual property, including patents, copyrights, trademarks, trade names, trade secrets, and online business elements (e.g. domain names, website material and source code, software configurations, business methods, and related material for an online business).

In accordance with another aspect of the present invention, the intellectual property rights are exchanged or transferred, but not necessarily the underlying product or services covered by the intellectual property rights.

In accordance with another aspect of the present invention, the exchange includes the following forms: buy-out, assignment, fixed price, auction, licensing, trade/barter (cross-assignment or cross-licensing), and investment (e.g. for privately traded stock shares with dividends and/or capital or equity gains).

In accordance with another aspect of the present invention, some, or all, of the transactions can be conducted online, including negotiation of terms, offer/counter-offer, all being facilitated by the forms and mechanisms of the website, without requiring the website hosting business to be directly involved.

In accordance with another aspect of the present invention, the website owner can facilitate off-line, private interaction directly between a buyer and seller. The buyer and/or seller can choose whether the exchange of negotiation information pertaining to the intellectual property is to be public or private.

In accordance with another aspect of the present invention, the information submitted by the seller is placed into a “classifieds” format termed a listing, and all exchanges that take place for the rights to the intellectual property described in the listing are consummated between the buyer and the seller. The website owner may or may not hold interest in, or control of, any transactions that transpire on or through the website. The website provides a structure and an enabling means for the transaction.

In accordance with another aspect of the present invention, the information is verified, detailed, and available for transaction via the terms, rules, and regulations conveyed in a legal contract. The space needed to contain the contract is provided by the website, which enables the seller to optionally construct a legal contract, or to download a pre-existing legal contract that supports the transaction of particular rights. The downloaded contracts may be viewed at any time by pressing a button on the website. The website may provide standard contract forms or clauses to assist the seller in constructing the contract.

In accordance with another aspect of the present invention, the website is supported by user/advertiser fees rather than sales commissions.

In accordance with another aspect of the present invention, a seller of intellectual property rights may post a time limited advertisement for a pre-paid fee, the advertisement being presented in a searchable format.

In accordance with another aspect of the present invention, a prospective buyer of intellectual property rights may post a time limited advertisement for a pre-paid fee, the advertisement being presented in a searchable format.

In accordance with another aspect of the present invention, an inventor or company may post a time limited “Help wanted/Investors needed/Job opportunity” advertisement for a pre-paid fee, the advertisement being presented in a searchable format. For example, an inventor may want help in reducing to practice, developing, or marketing his inventive concept. Another example would be an inventor or start-up company may want help with venture capital. The aid/help could include, for example, technical or business consultation, technical work-for-hire, co-inventorship, investment capital, etc. Payment for help/aid can take non-monetary forms.

In accordance with another aspect of the present invention, a search engine is provided for an investor to search the website for investor criteria.

In accordance with another aspect of the present invention, individuals seeking investors can upload their business plan to the website. A button displayed in the individual's listing will access the plan for viewing in it's entirety by potential investors.

In accordance with another aspect of the present invention, an escrow account is provided for holding a deposit from a prospective buyer while purchase agreements are pending. An escrow deposit of a predetermined value preserves a priority right for purchase for a pre-arranged time period subject to pre-arranged conditions. The escrow deposit can take non-monetary forms as well.

In accordance with another aspect of the present invention, the escrow account can be managed by a qualified third party under contract with the website owner.

In accordance with another aspect of the present invention, the intellectual property listing information, as well as most other information displayed on the website, can be provided in multiple languages.

The inventive process provides an affordable and ethical means for private inventors to market their intellectual property rights when they do not wish to manufacture and/or sell the invention themselves.

The process limits disclosure of pending applications not otherwise made public. Outside information is general in nature, whereas inside information is only available to serious potential clients, who may be required to agree to confidentiality terms. The process also encourages interaction between corporations and private inventors, and provides an attractive tool for companies to place intellectual property needs into classified ad style listings.

Still other benefits and advantages of the invention will become apparent to those skilled in the art upon a reading and understanding of the following detailed specification.

### III. BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein:

FIG. 1 is a print-out from the inventive website;

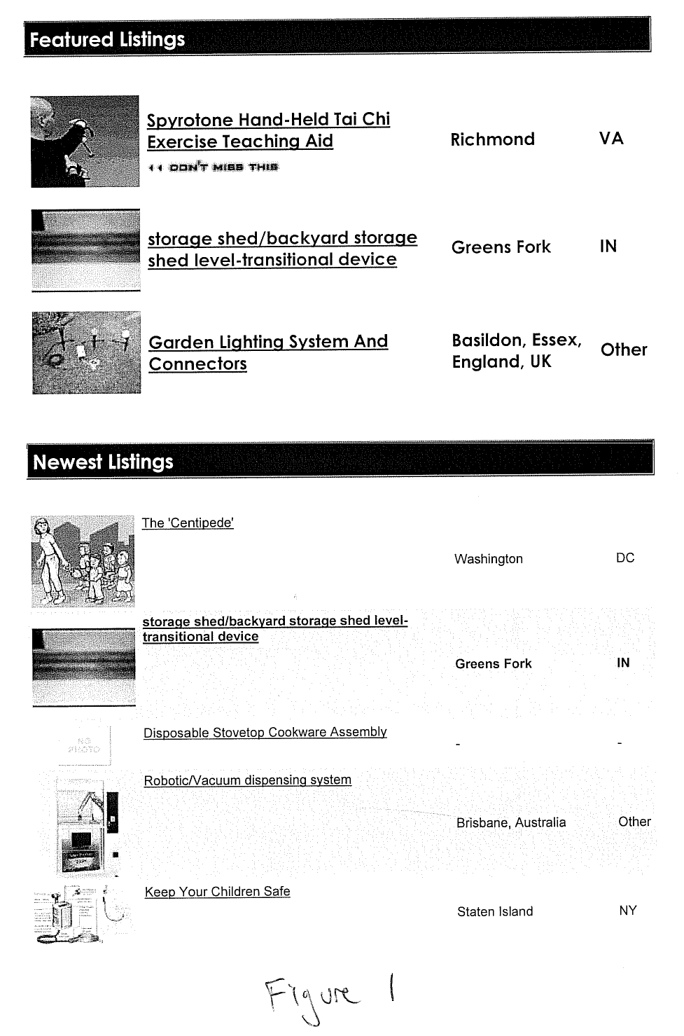

FIG. 2 is a printout from the inventive website;

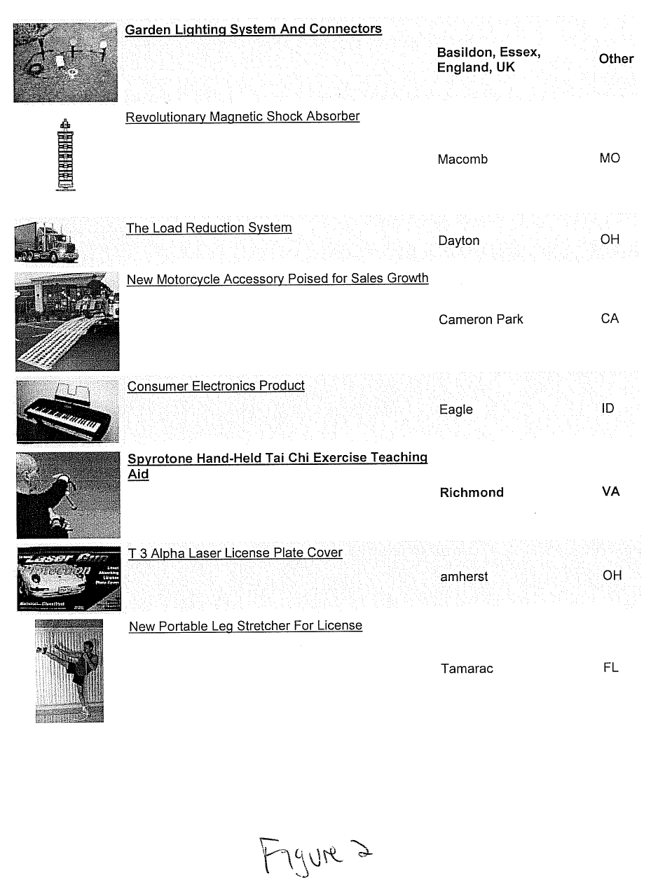

FIG. 3 is a print-out from the inventive website;

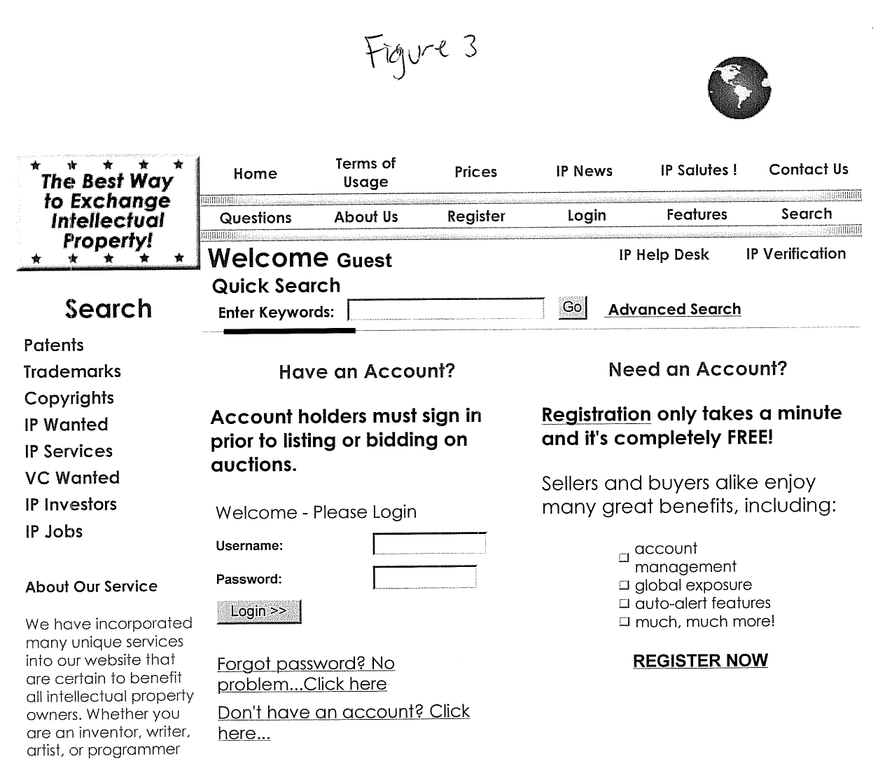

FIG. 4 is a print-out from the inventive website;

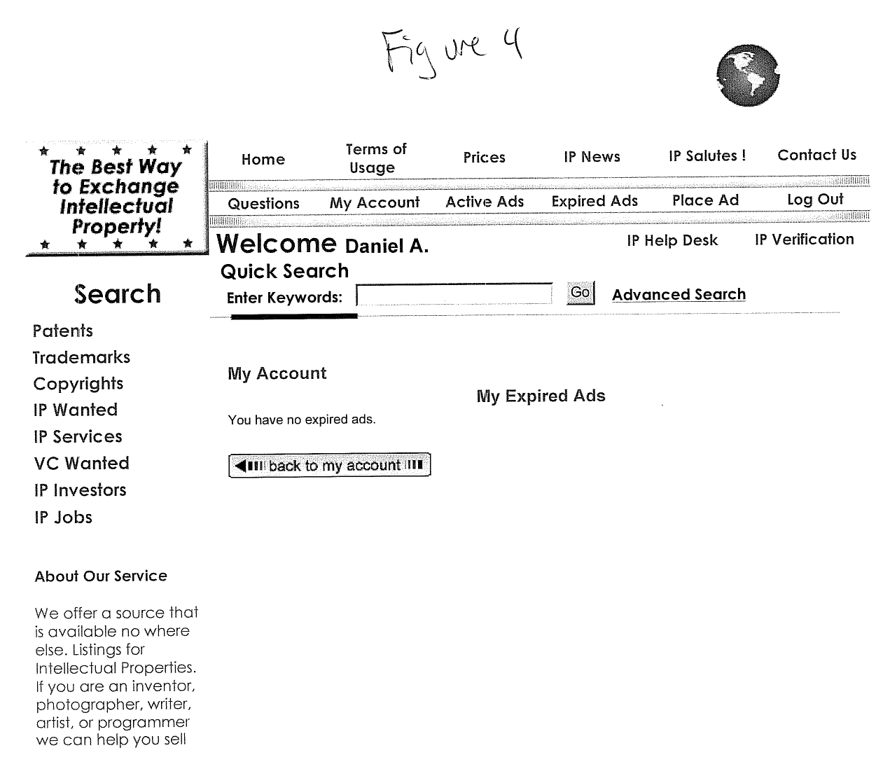

FIG. 5 is a print-out from the inventive website;

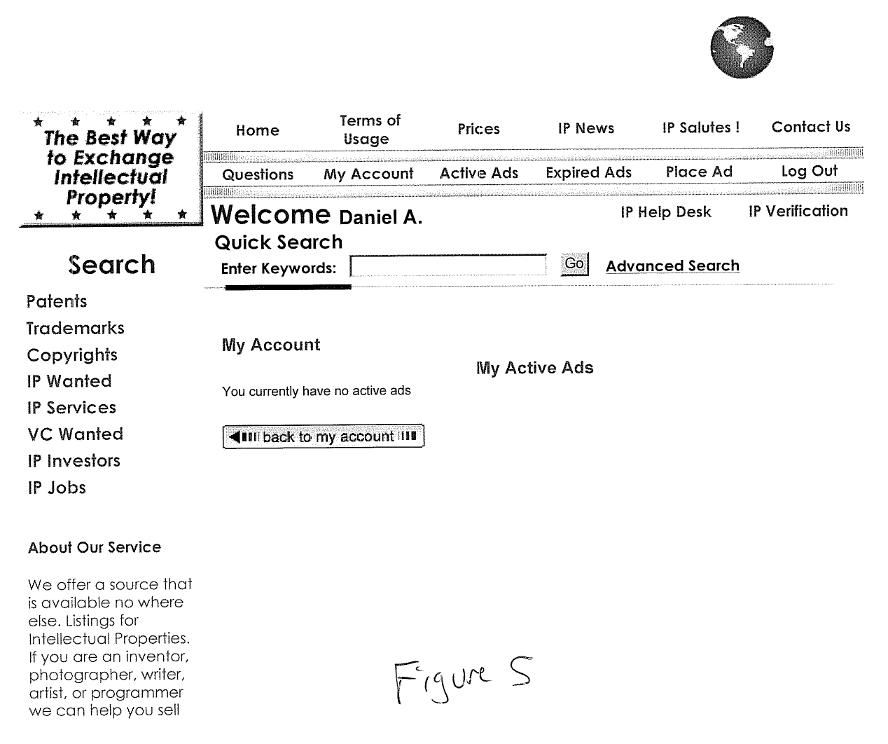

FIG. 6 is a print-out from the inventive website;

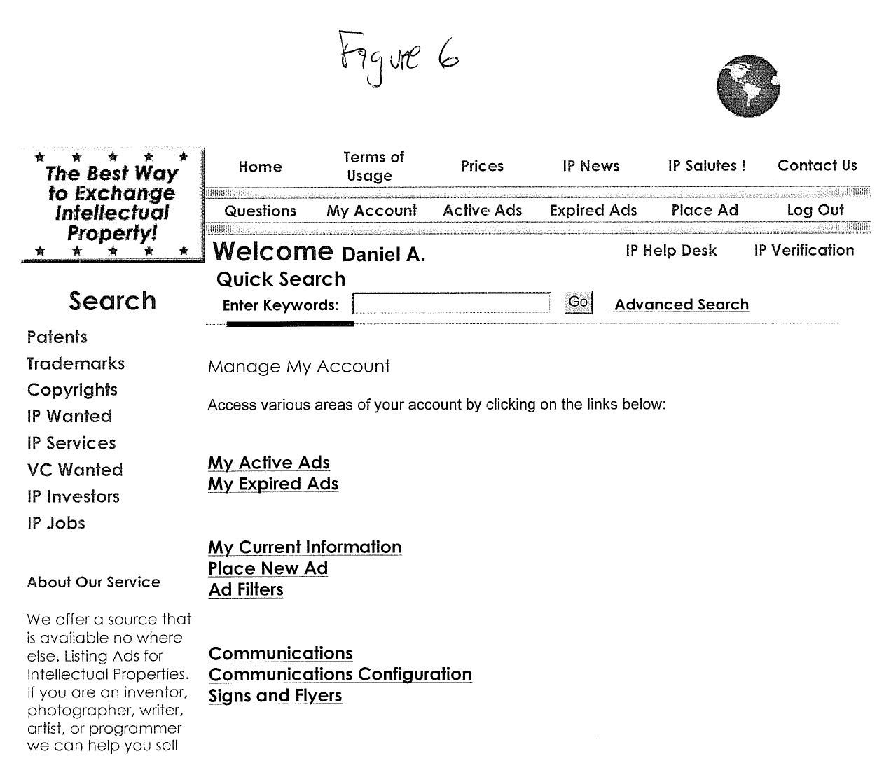

FIG. 7 is a print-out from the inventive website;

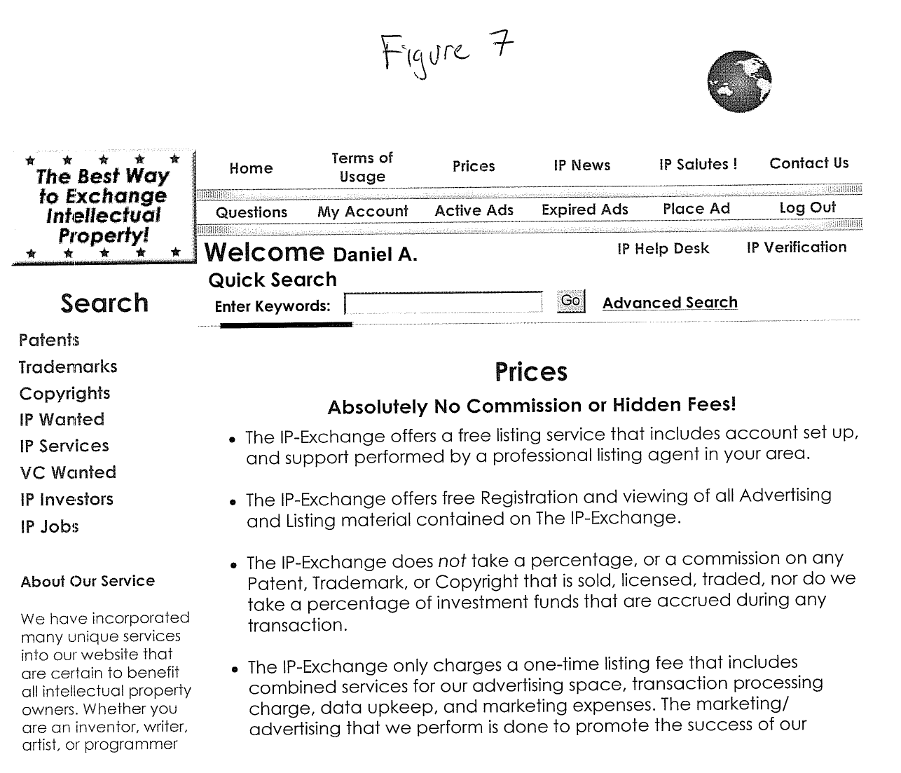

FIG. 8 is a print-out from the inventive website;

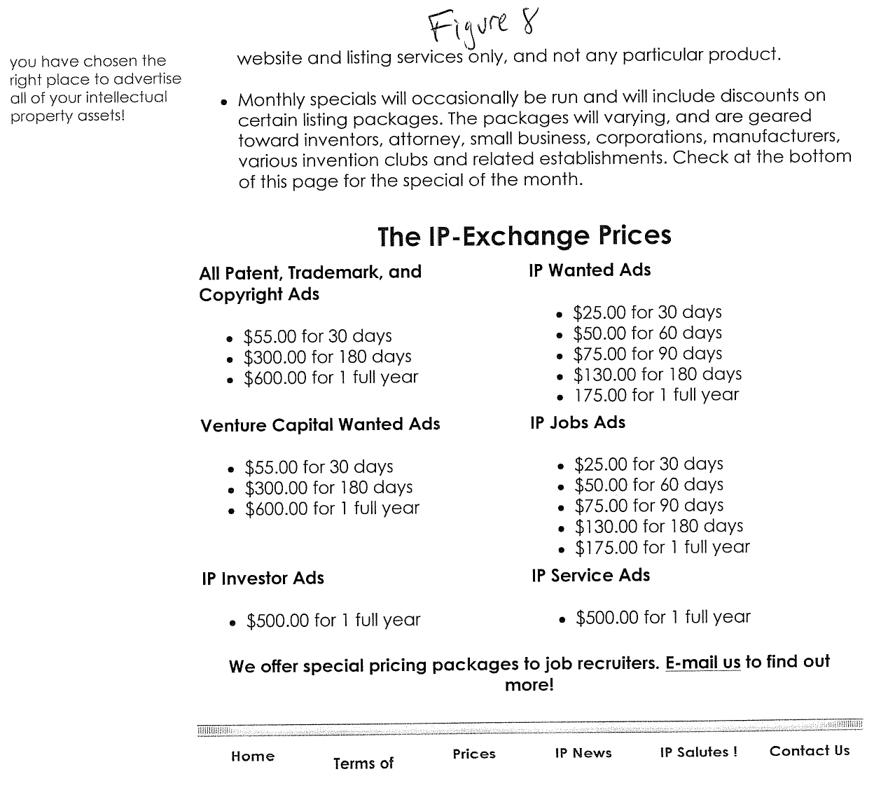

FIG. 9 is a print-out from the inventive website;

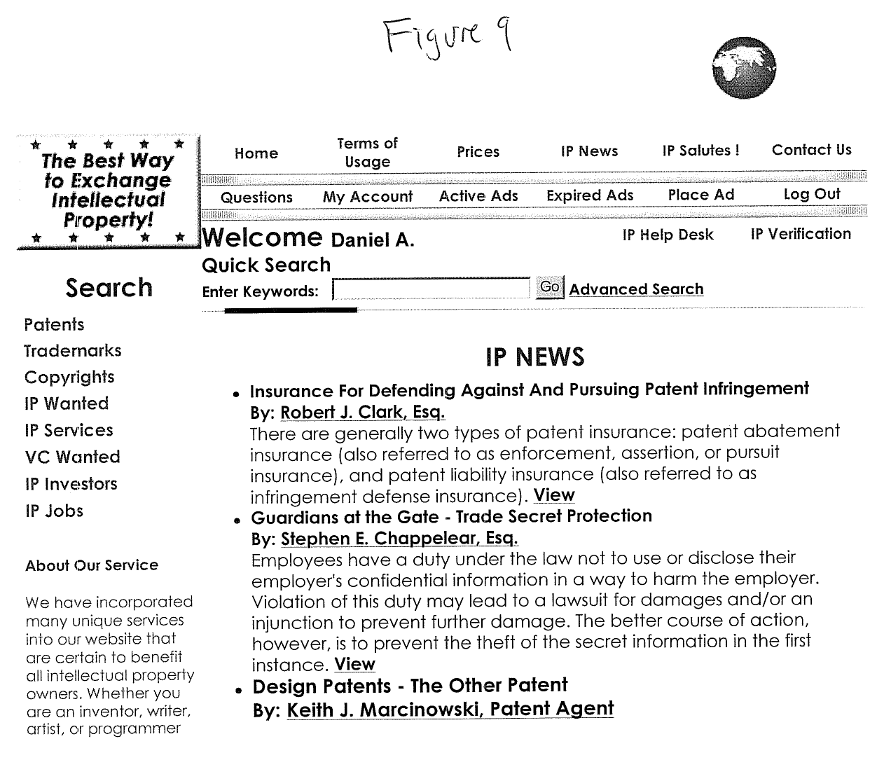

FIG. 10 is a print-out from the inventive website;

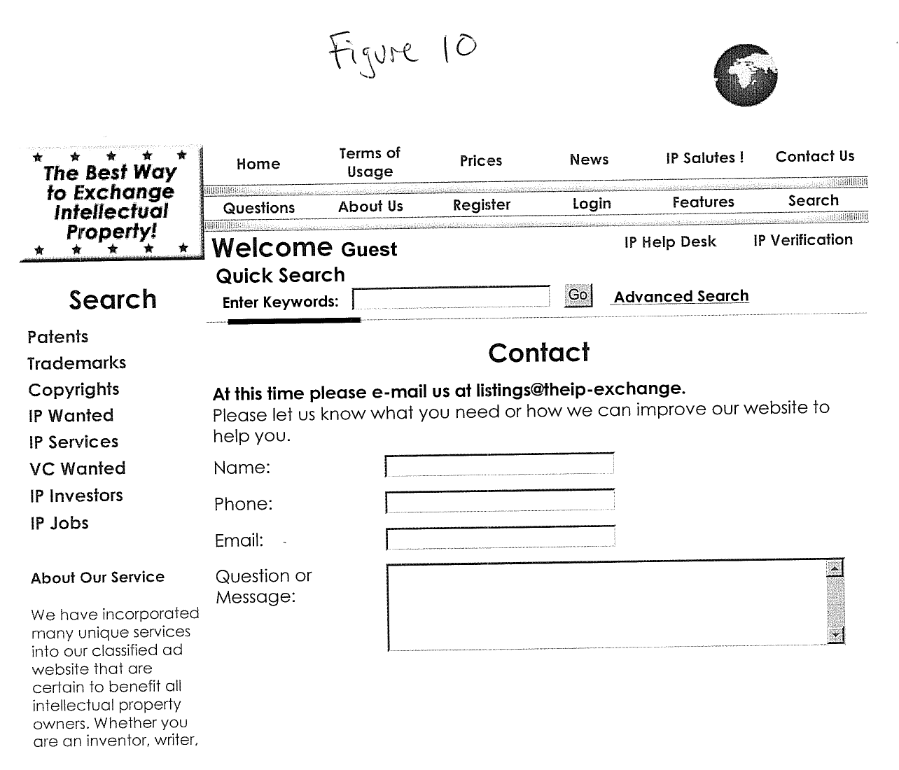

FIG. 11 is a print-out from the inventive website;

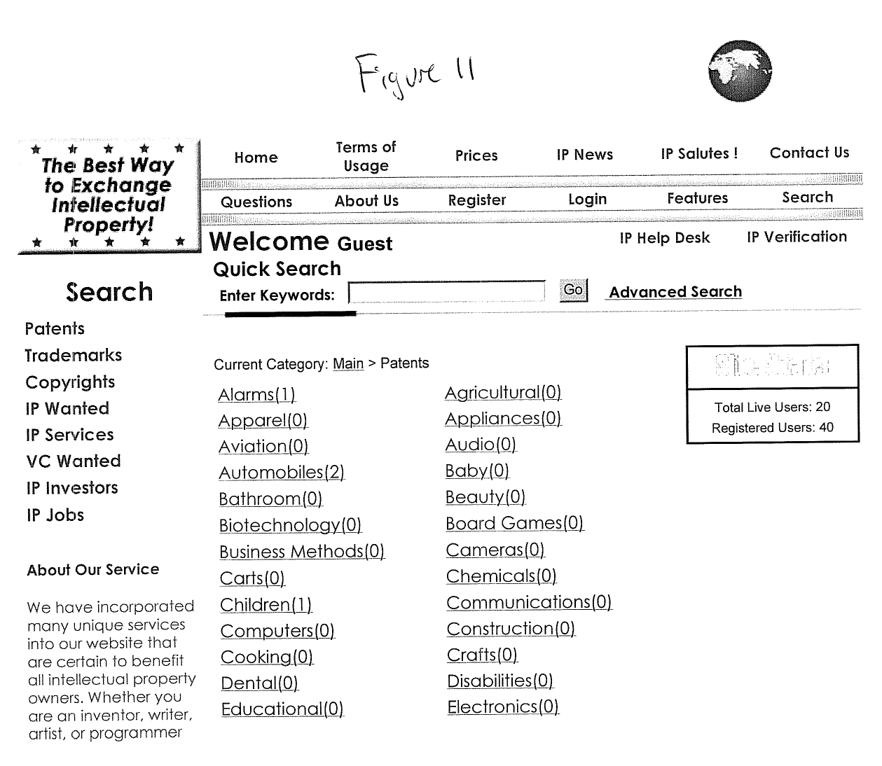

FIG. 12 is a print-out from the inventive website;

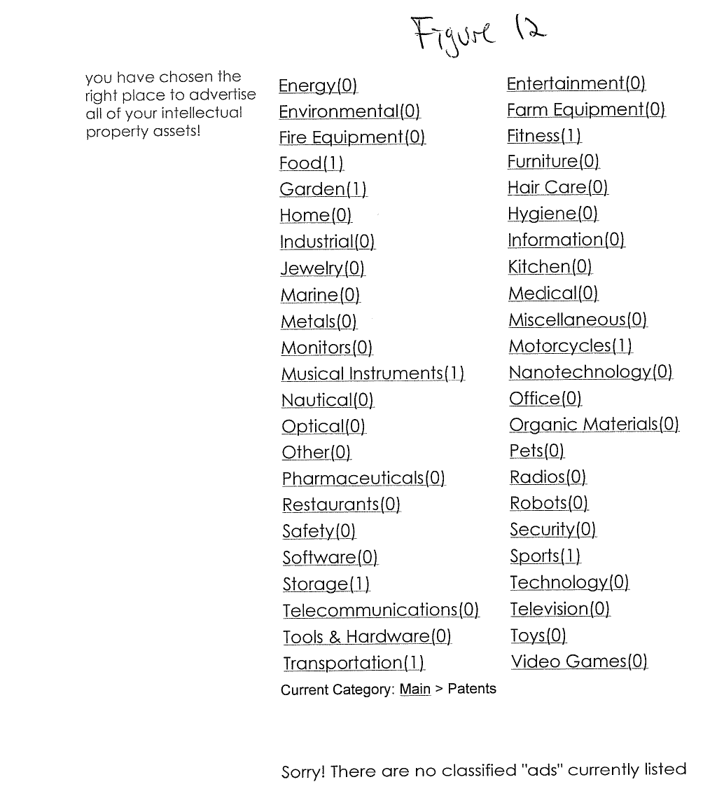

FIG. 13 is a print-out from the inventive website;

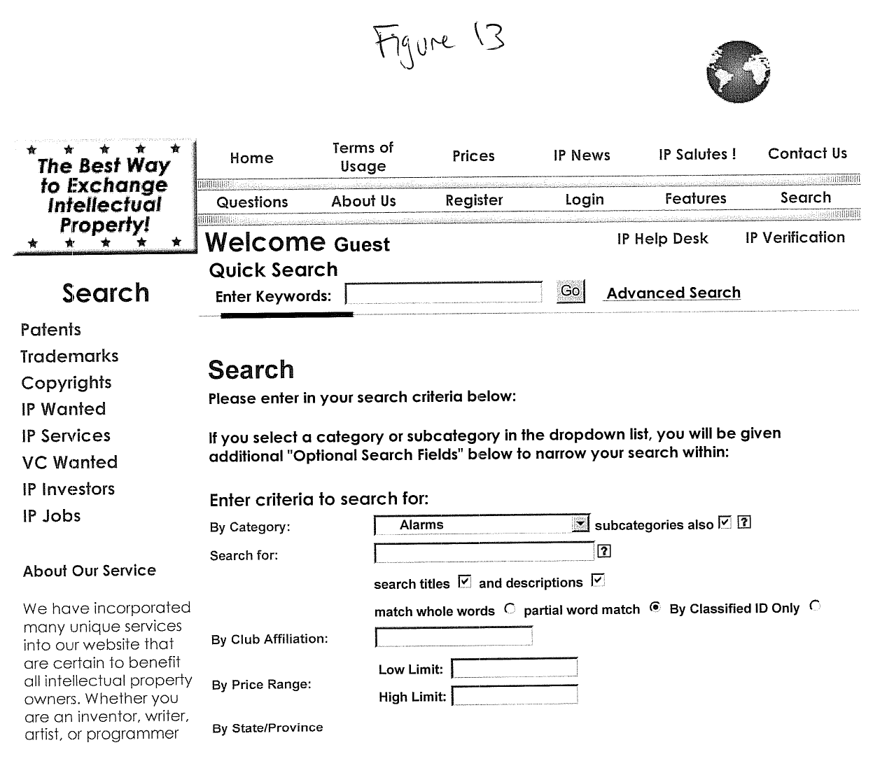

FIG. 14 is a print-out from the inventive website;

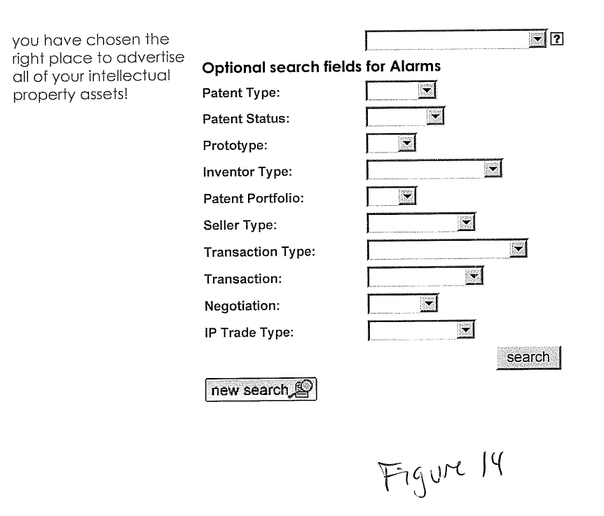

FIG. 15 is a print-out from the inventive website;

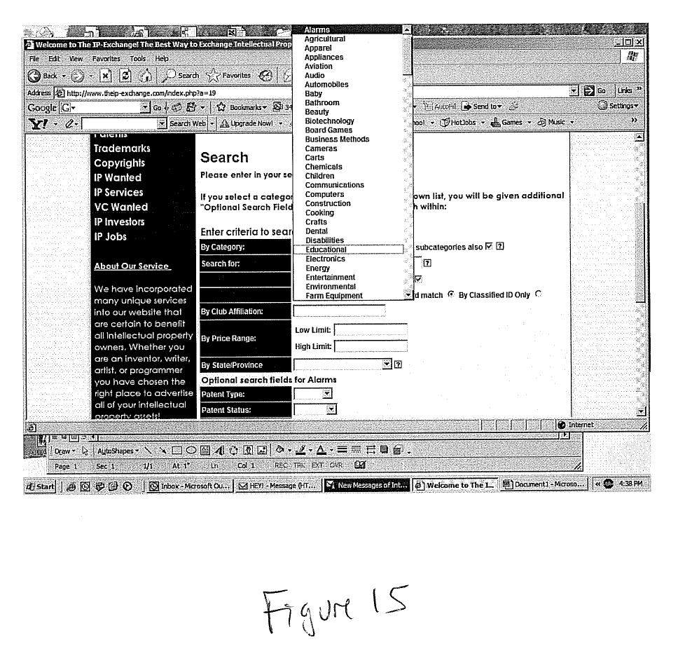

FIG. 16 is a print-out from the inventive website;

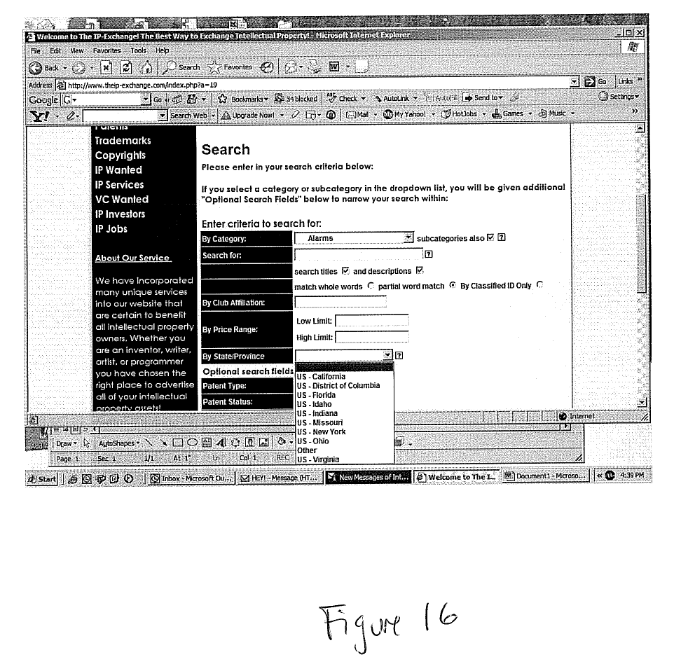

FIG. 17 is a print-out from the inventive website;

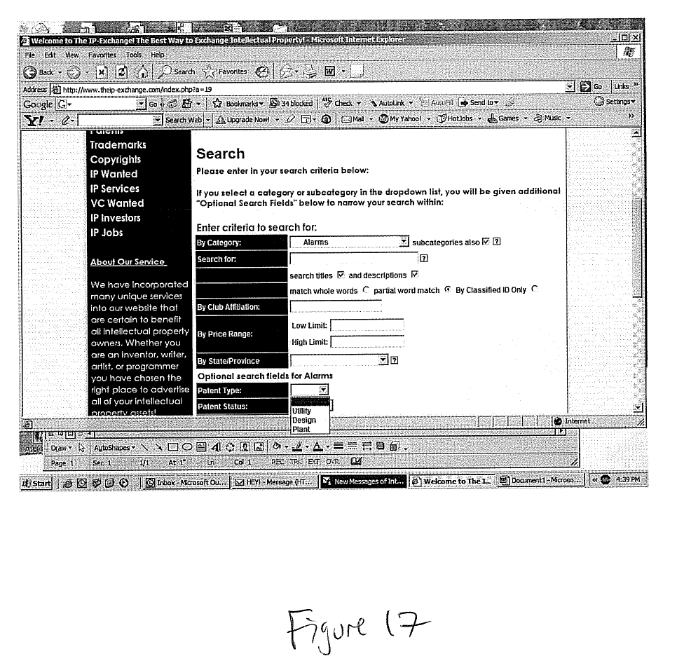

FIG. 18 is a print-out from the inventive website;

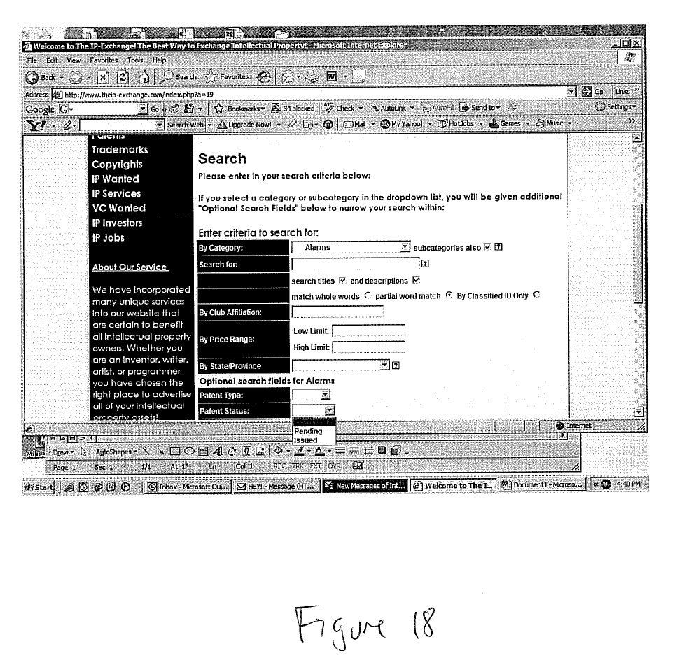

FIG. 19 is a print-out from the inventive website;

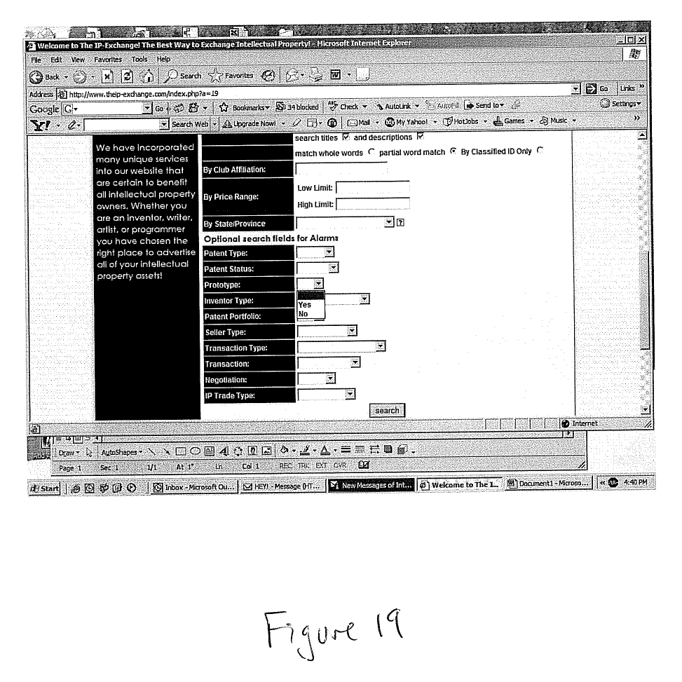

FIG. 20 is a print-out from the inventive website;

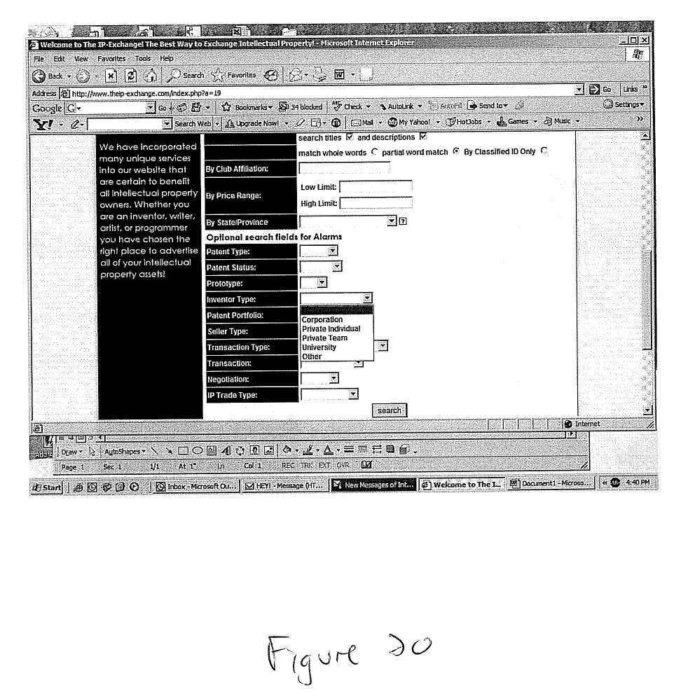

FIG. 21 is a print-out from the inventive website;

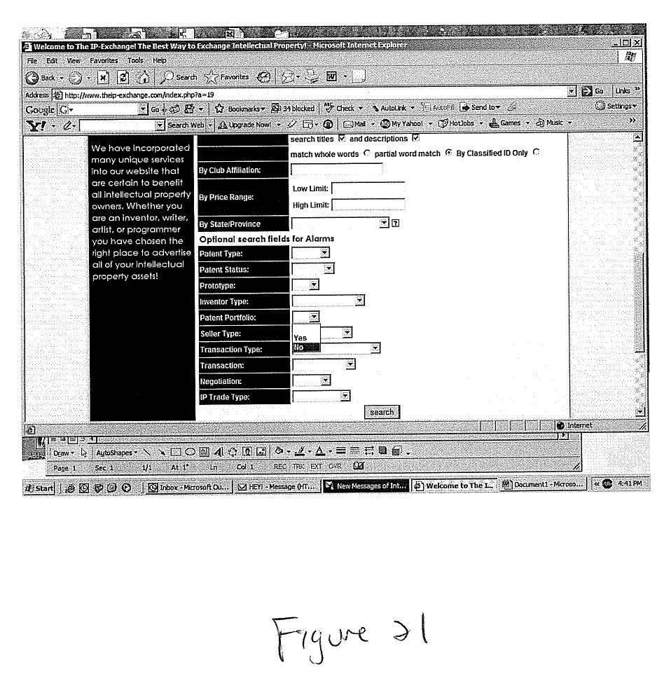

FIG. 22 is a print-out from the inventive website;

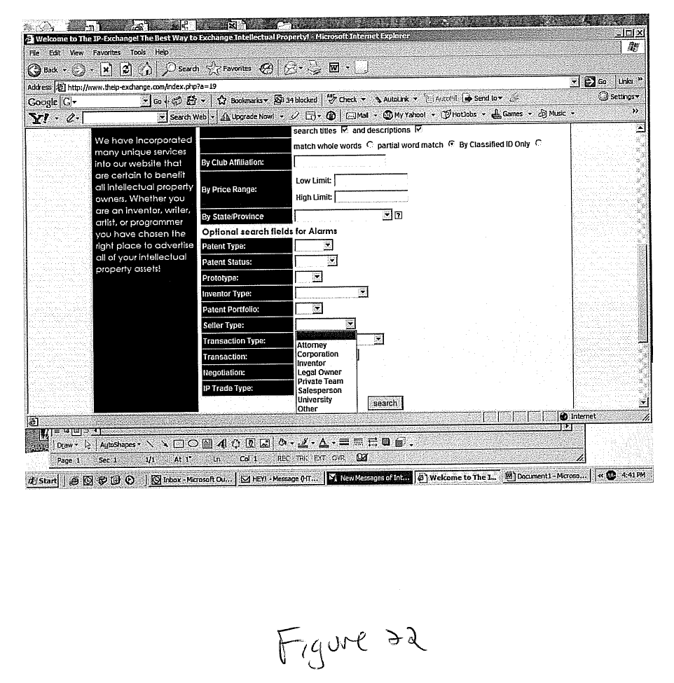

FIG. 23 is a print-out from the inventive website;

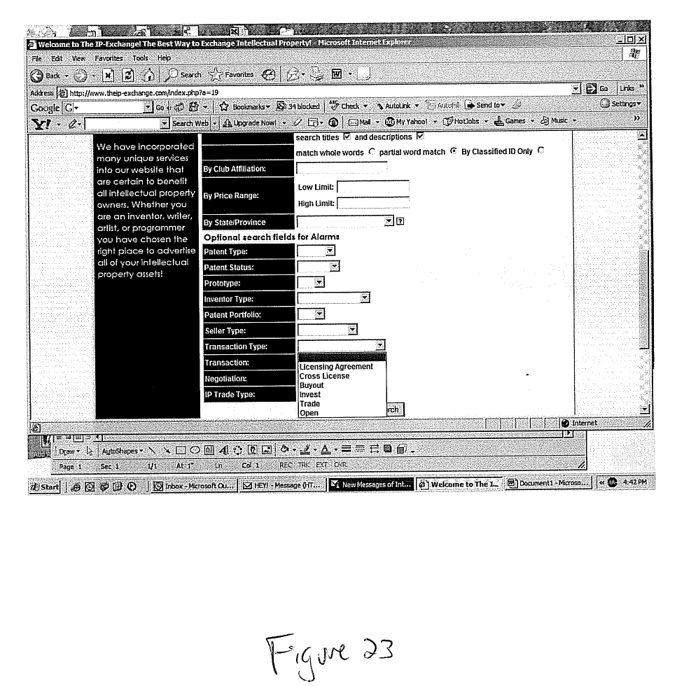

FIG. 24 is a print-out from the inventive website;

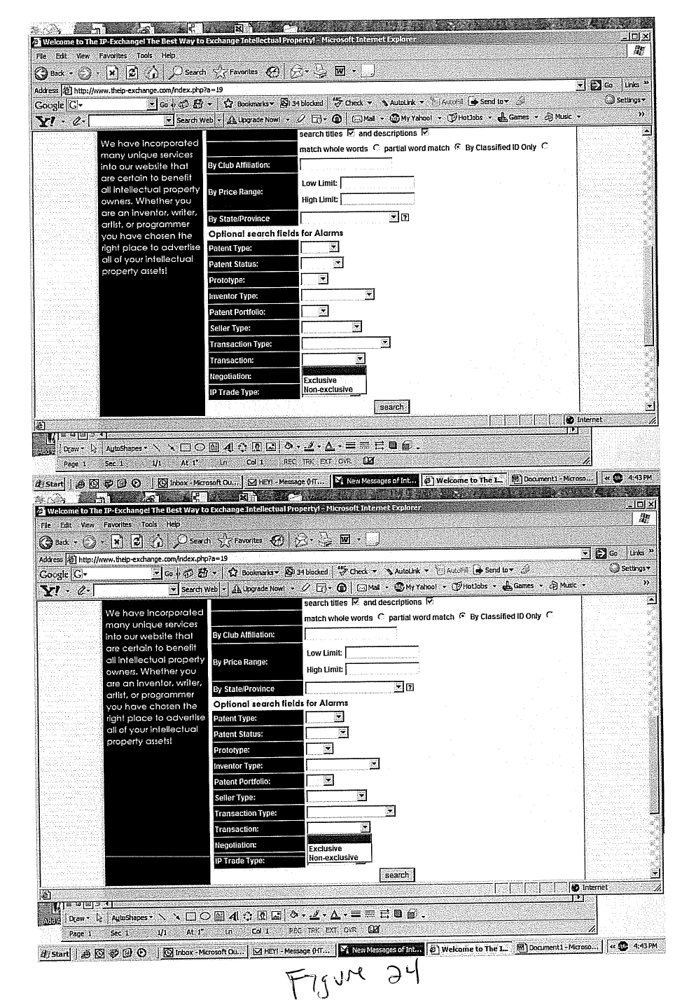

FIG. 25 is a print-out from the inventive website;

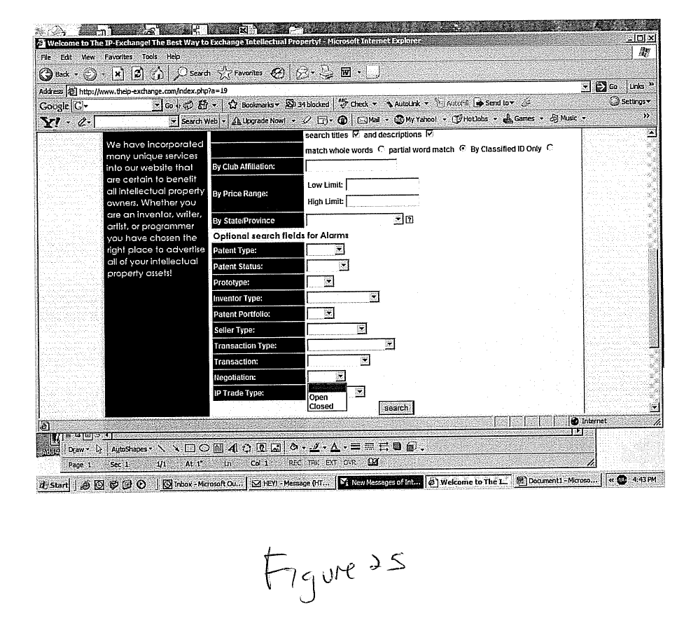

FIG. 26 is a print-out from the inventive website;

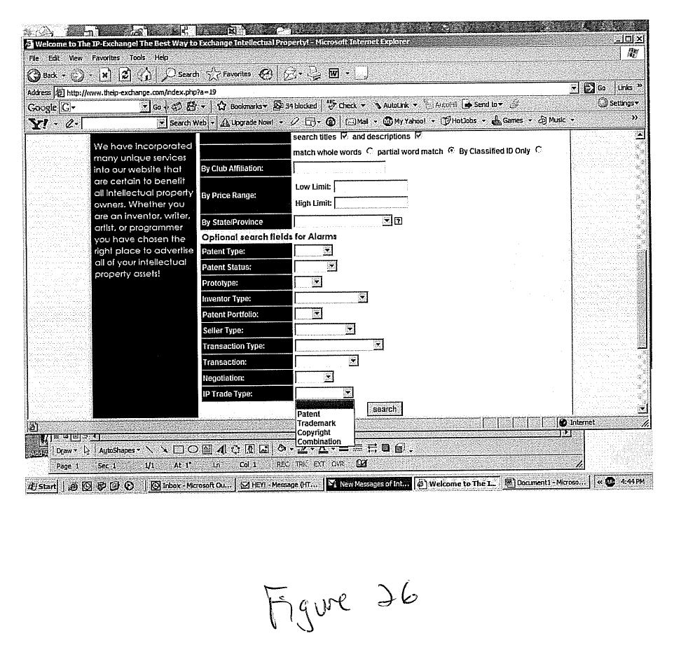

FIG. 27 is a print-out from the inventive website;

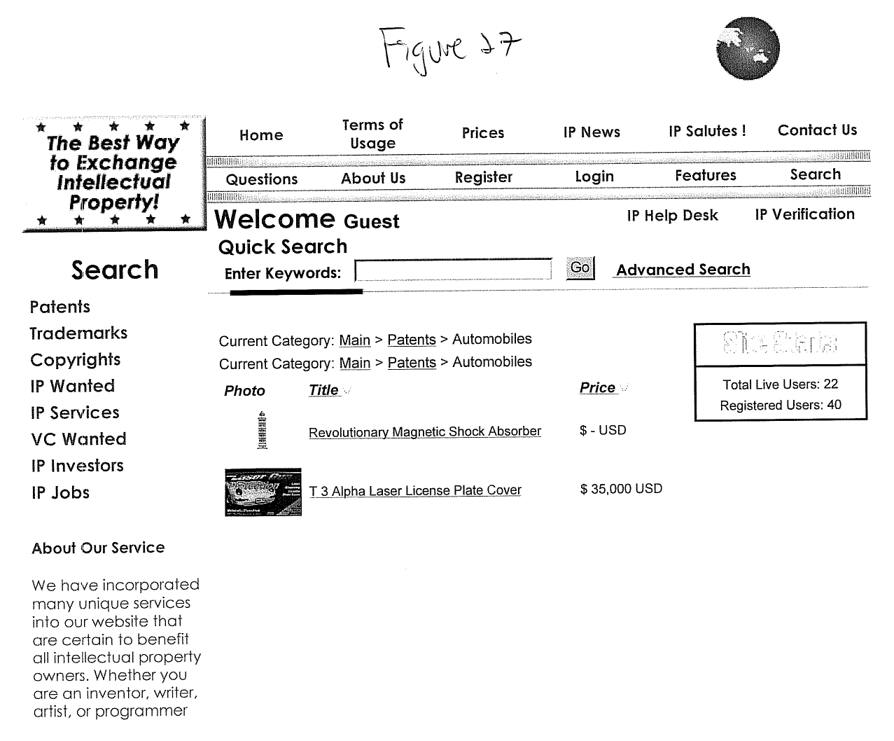

FIG. 28 is a print-out from the inventive website;

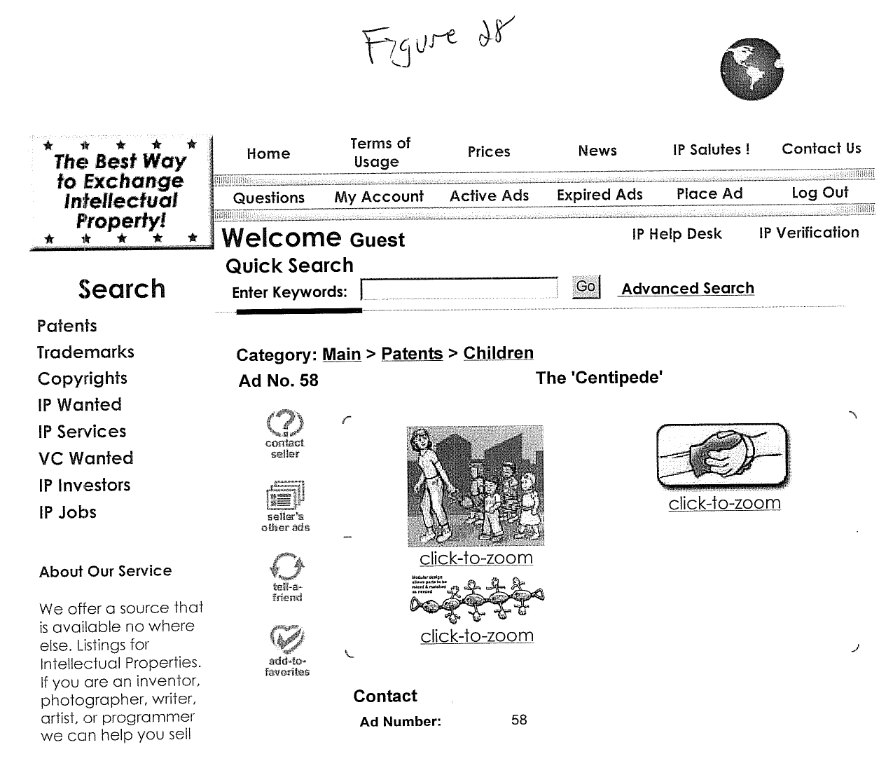

FIG. 29 is a print-out from the inventive website;

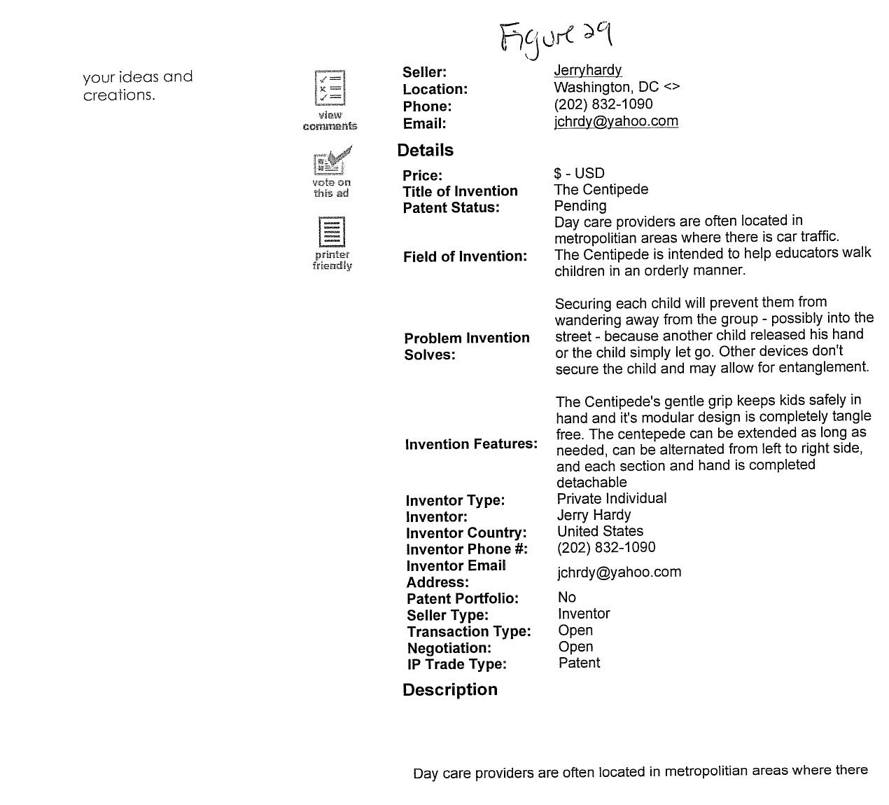

FIG. 30 is a print-out from the inventive website;

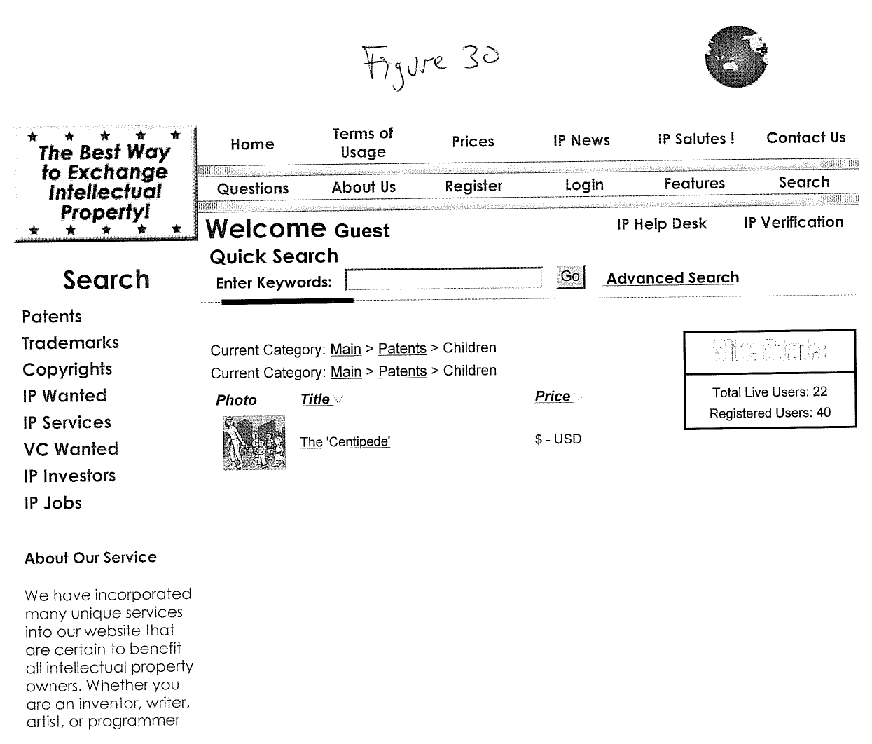

FIG. 31 is a print-out from the inventive website;

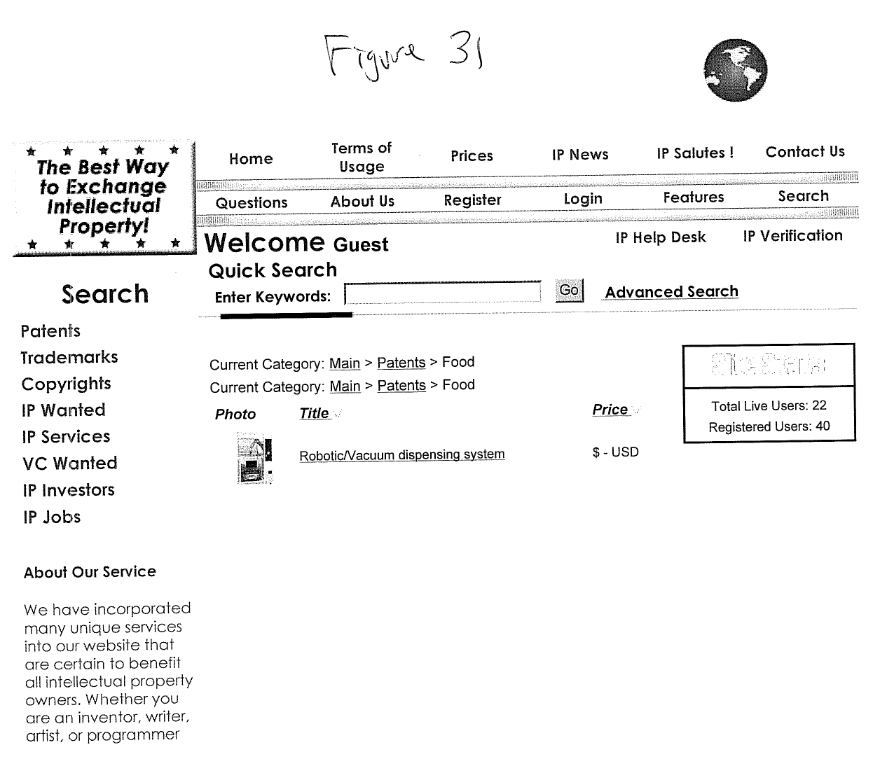

FIG. 32 is a print-out from the inventive website;

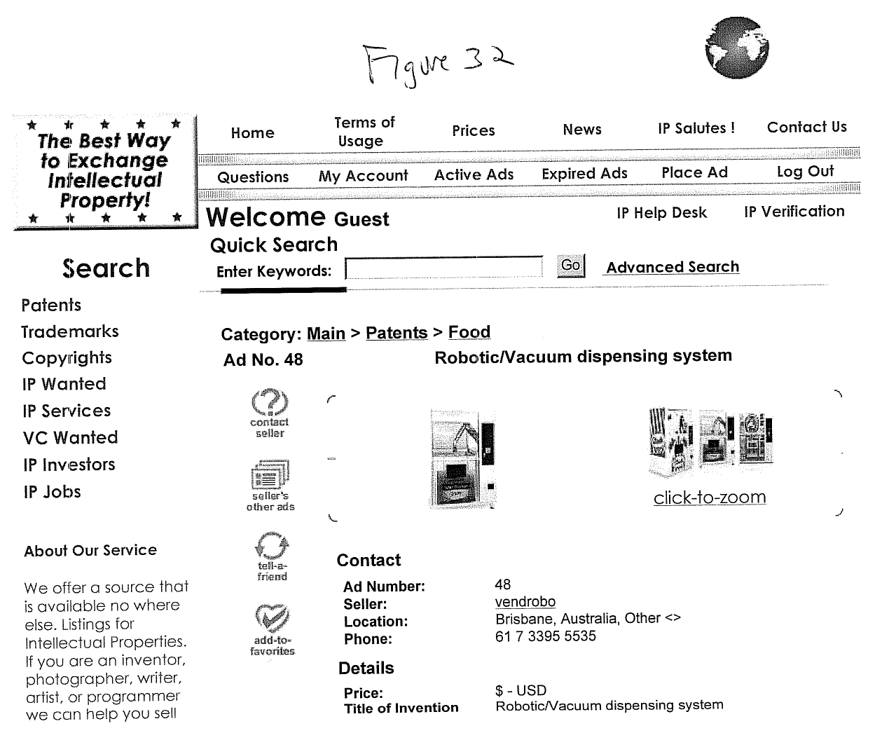

FIG. 33 is a print-out from the inventive website;

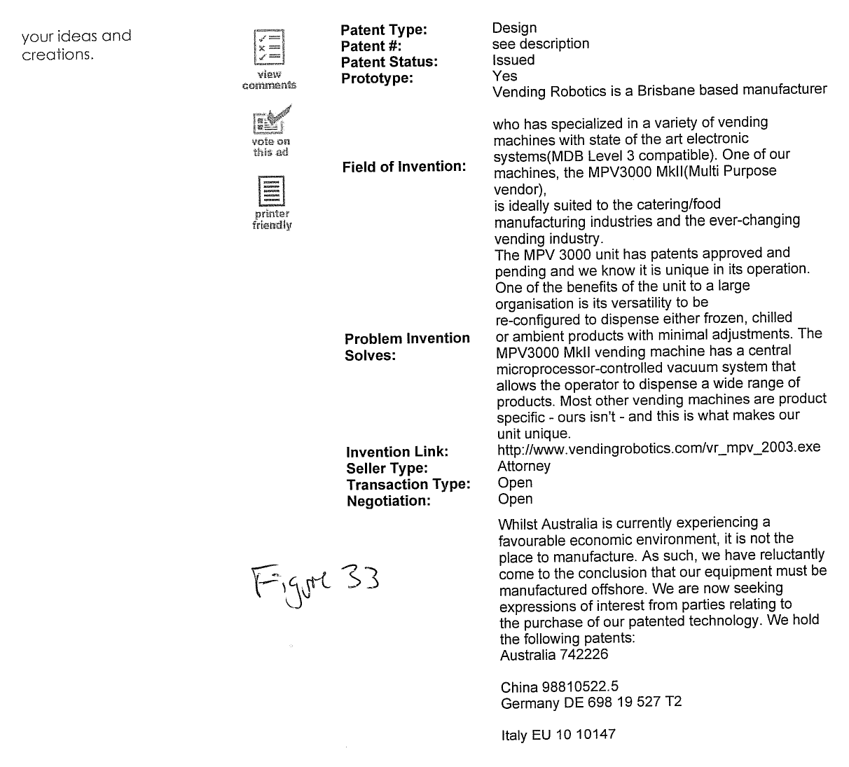

FIG. 34 is a print-out from the inventive website;

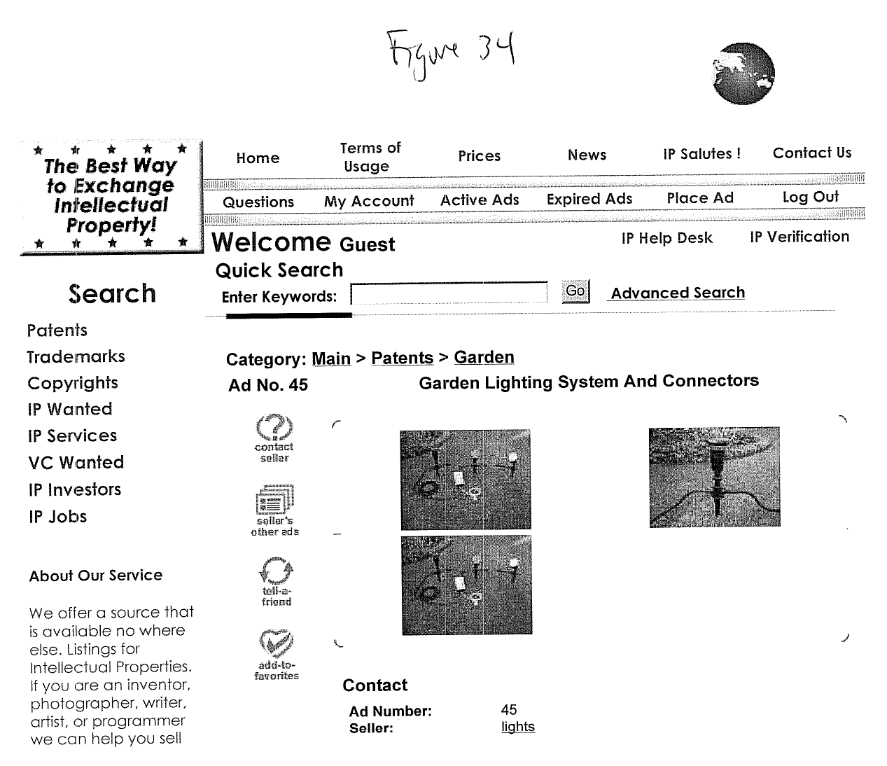

FIG. 35 is a print-out from the inventive website;

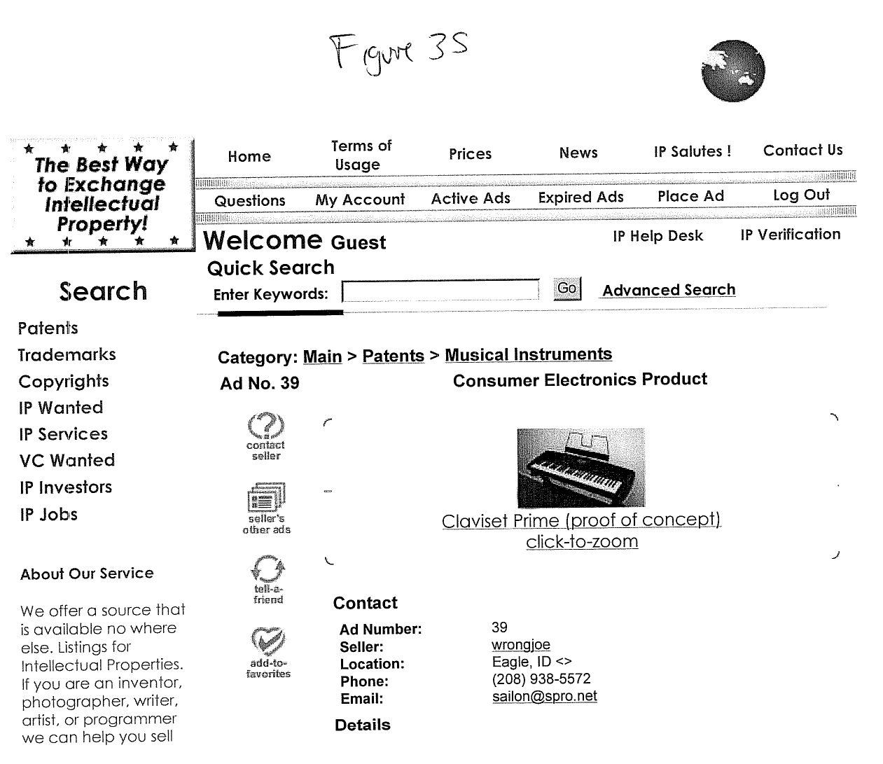

FIG. 36 is a print-out from the inventive website;

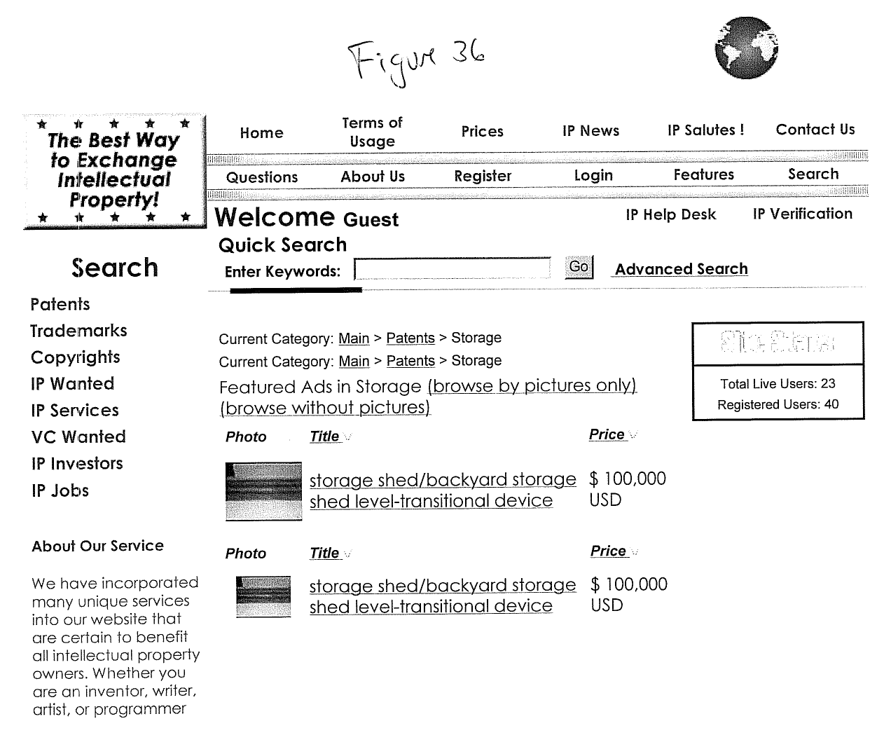

FIG. 37 is a print-out from the inventive website;

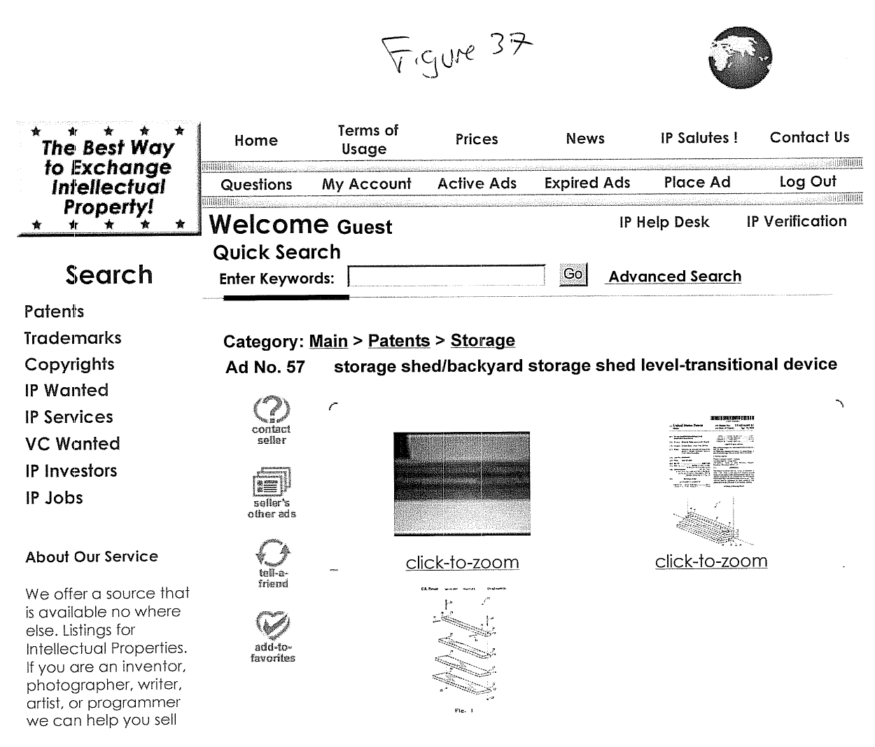

FIG. 38 is a print-out from the inventive website;

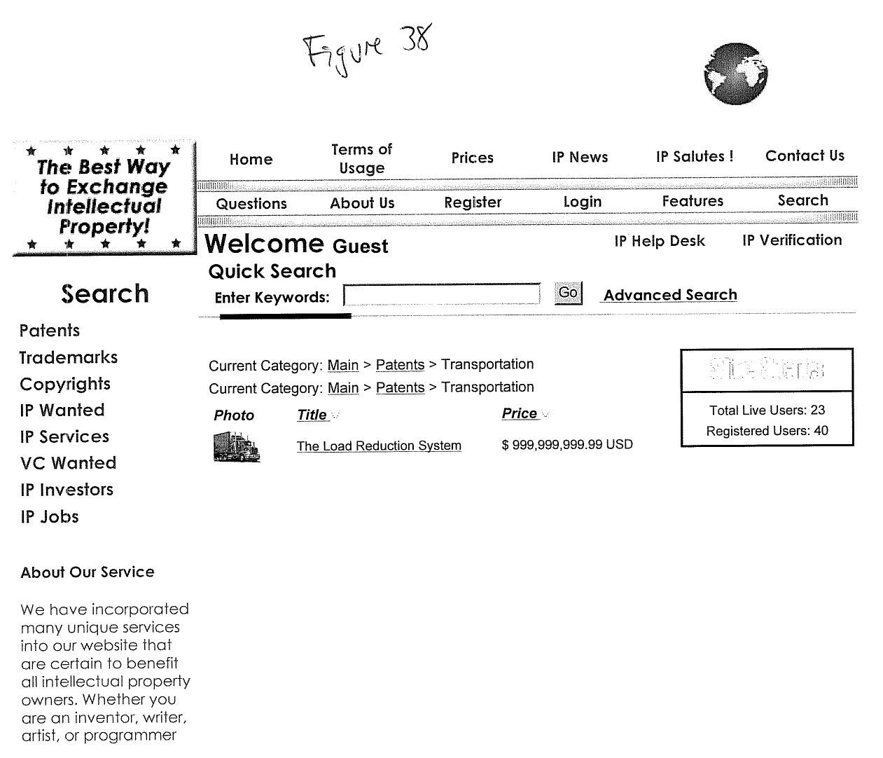

FIG. 39 is a print-out from the inventive website;

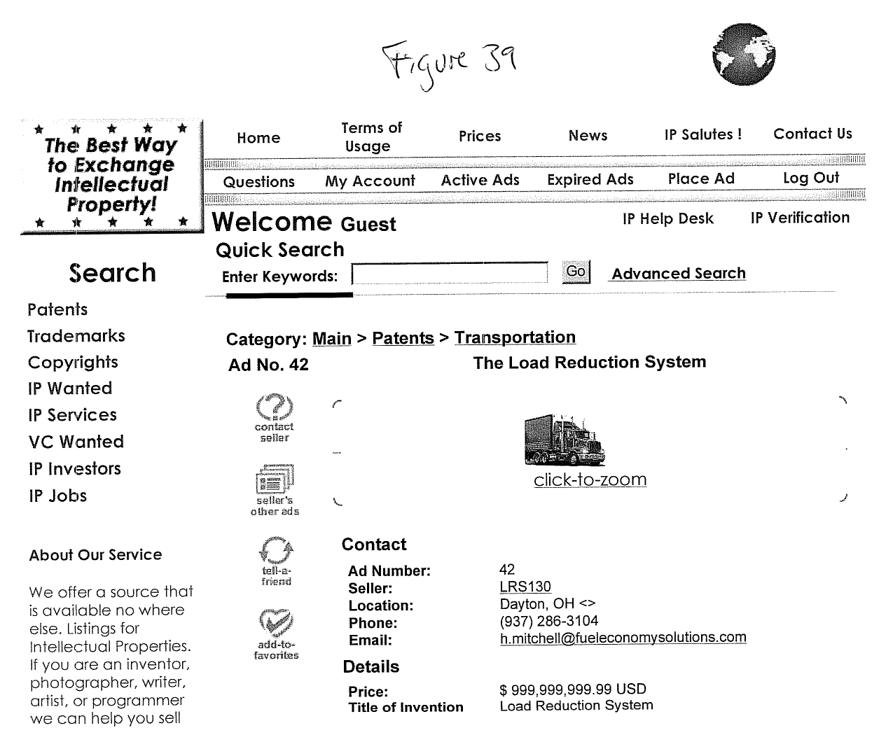

FIG. 40 is a print-out from the inventive website;

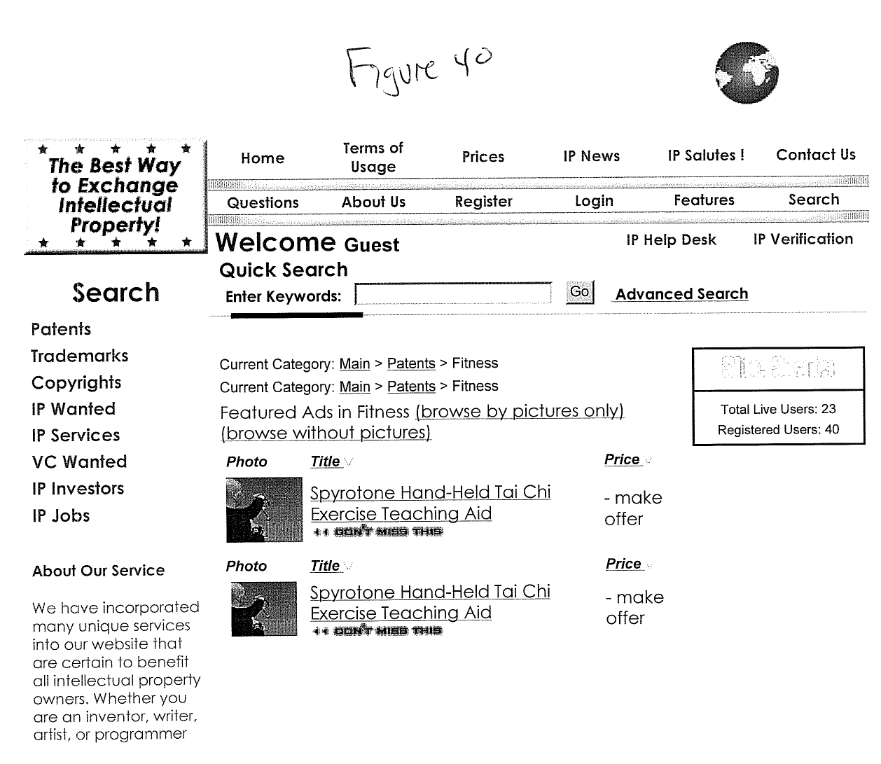

FIG. 41 is a print-out from the inventive website;

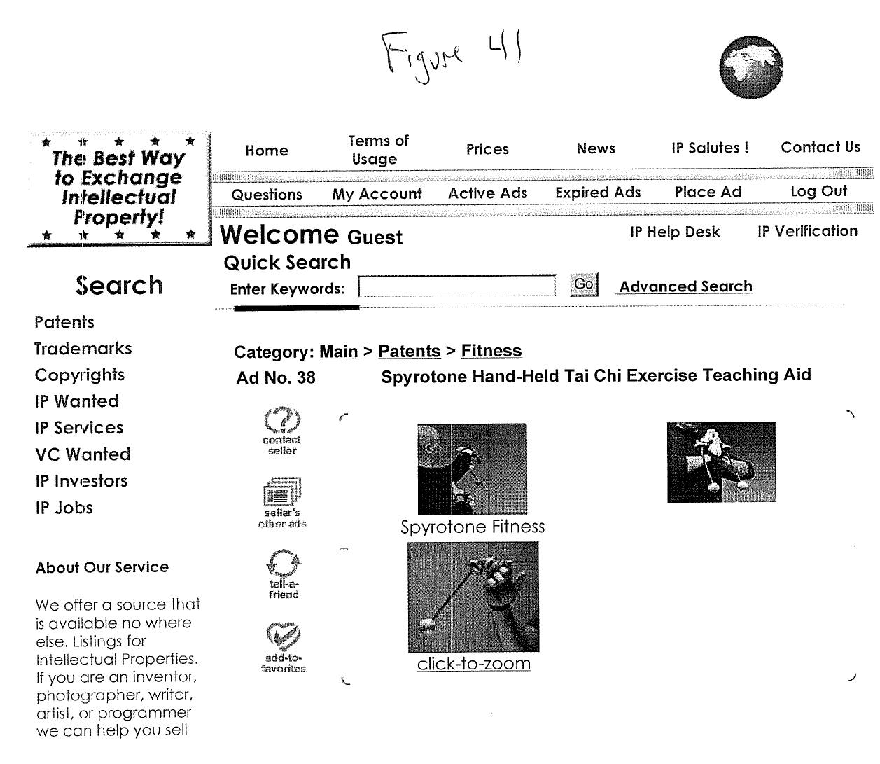

FIG. 42 is a print-out from the inventive website;

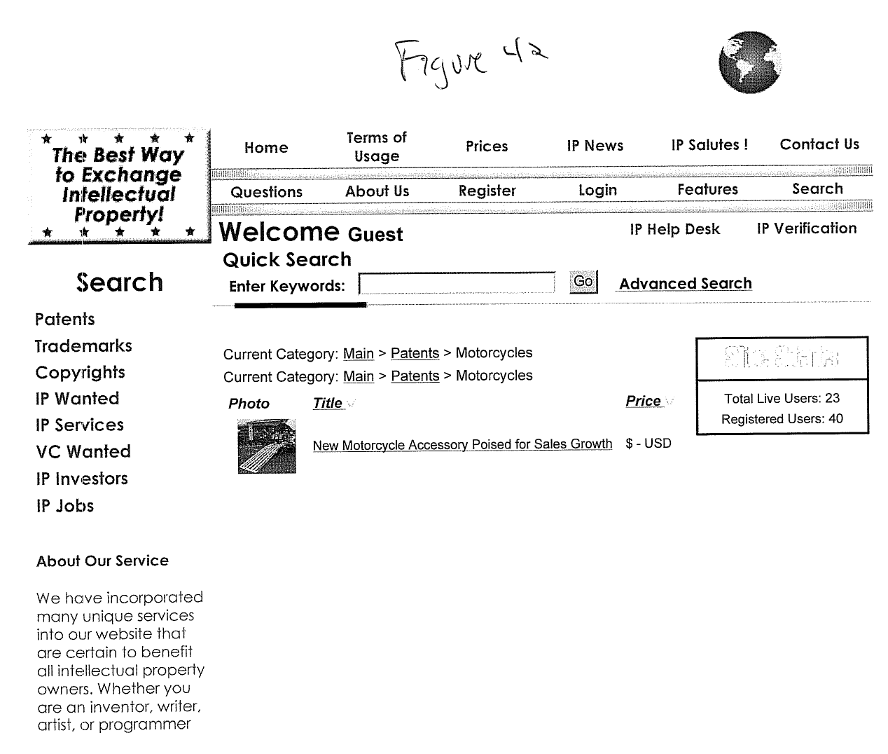

FIG. 43 is a print-out from the inventive website;

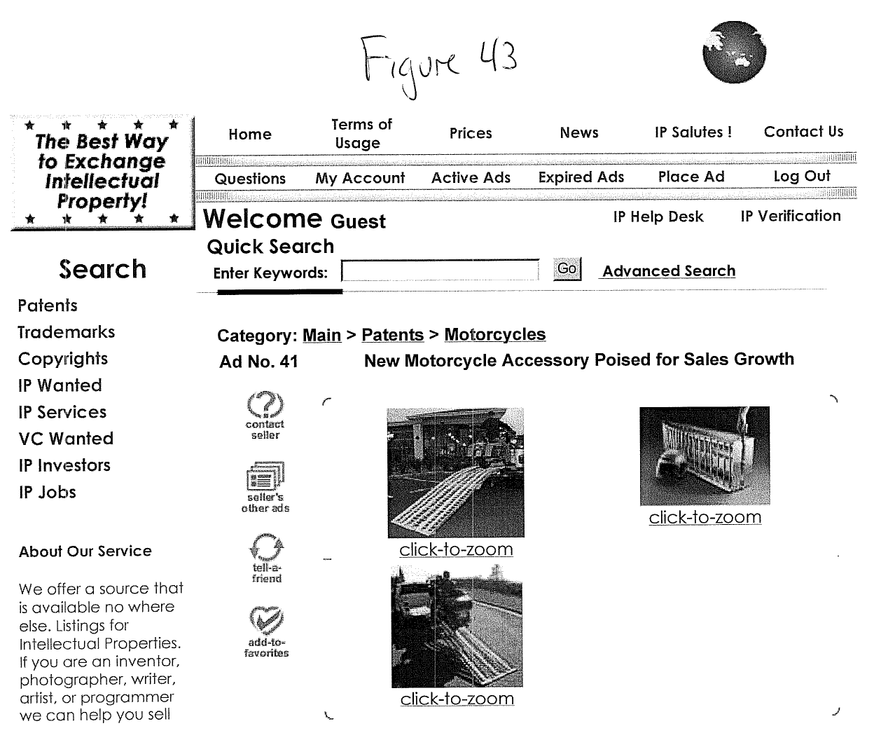

FIG. 44 is a print-out from the inventive website;

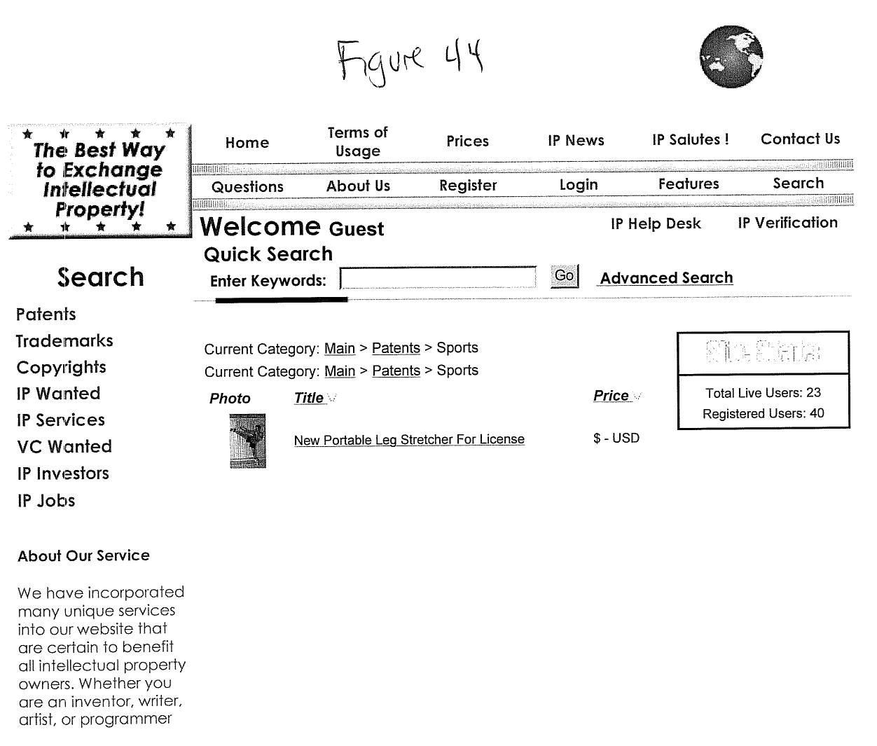

FIG. 45 is a print-out from the inventive website;

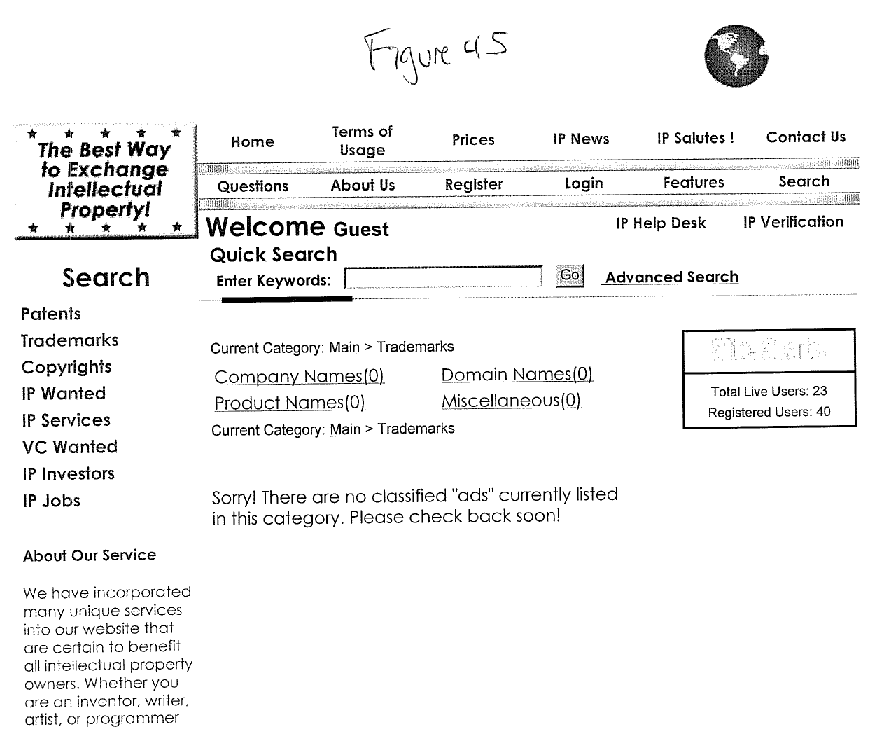

FIG. 46 is a print-out from the inventive website;

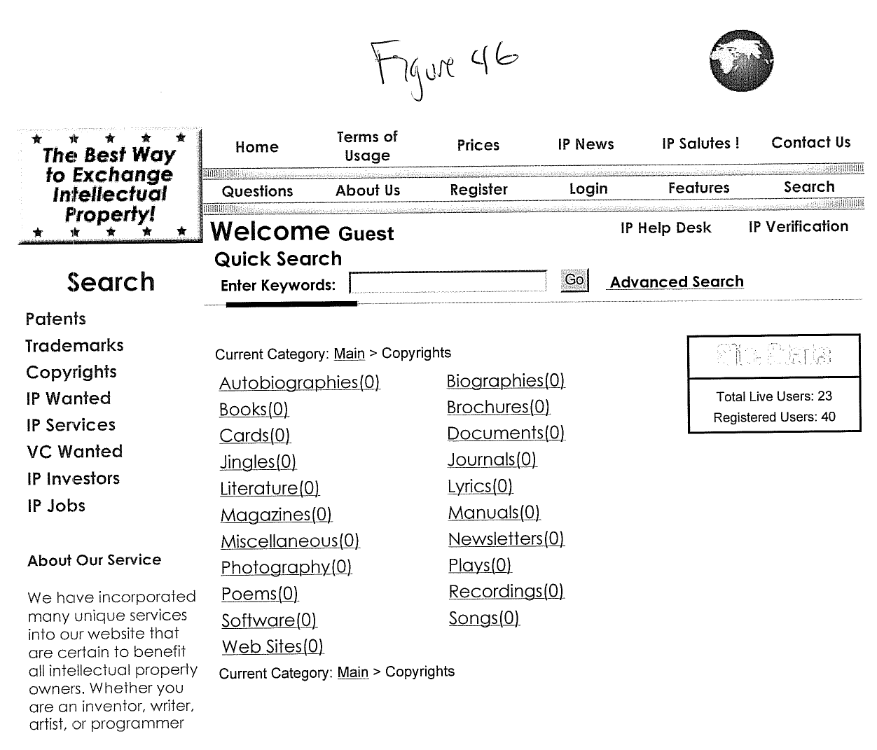

FIG. 47 is a print-out from the inventive website;

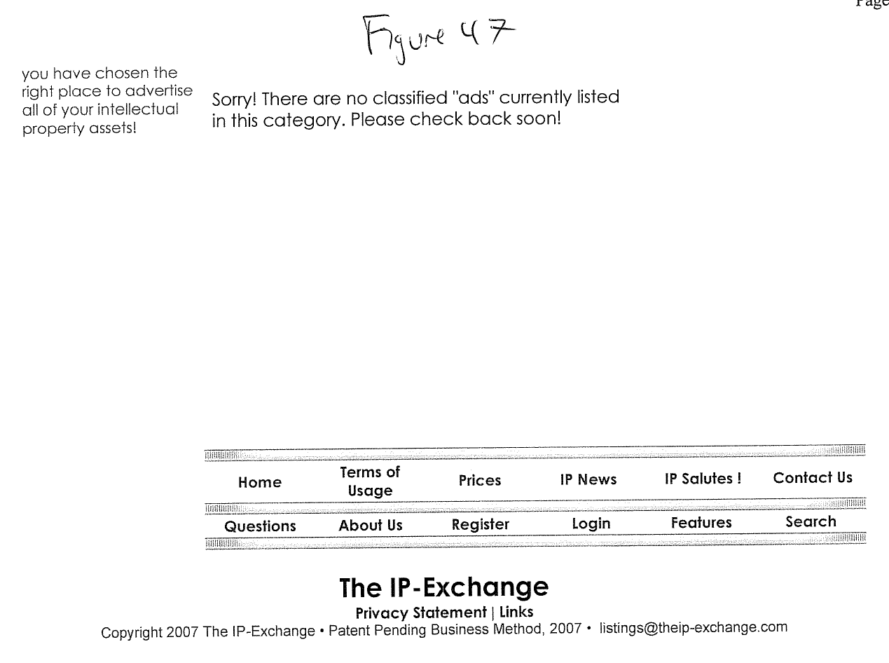

FIG. 48 is a print-out from the inventive website;

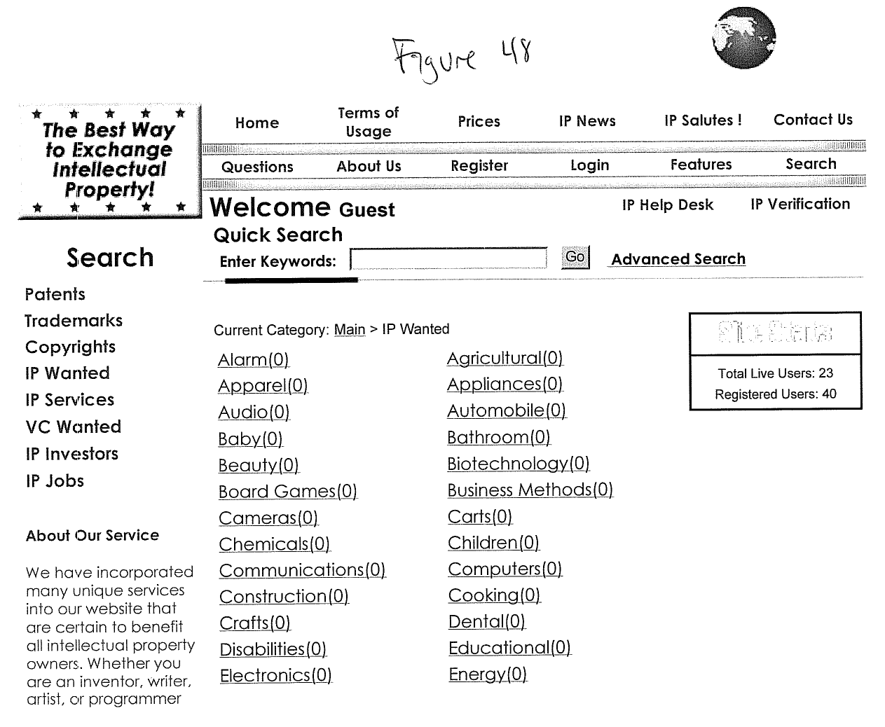

FIG. 49 is a print-out from the inventive website;

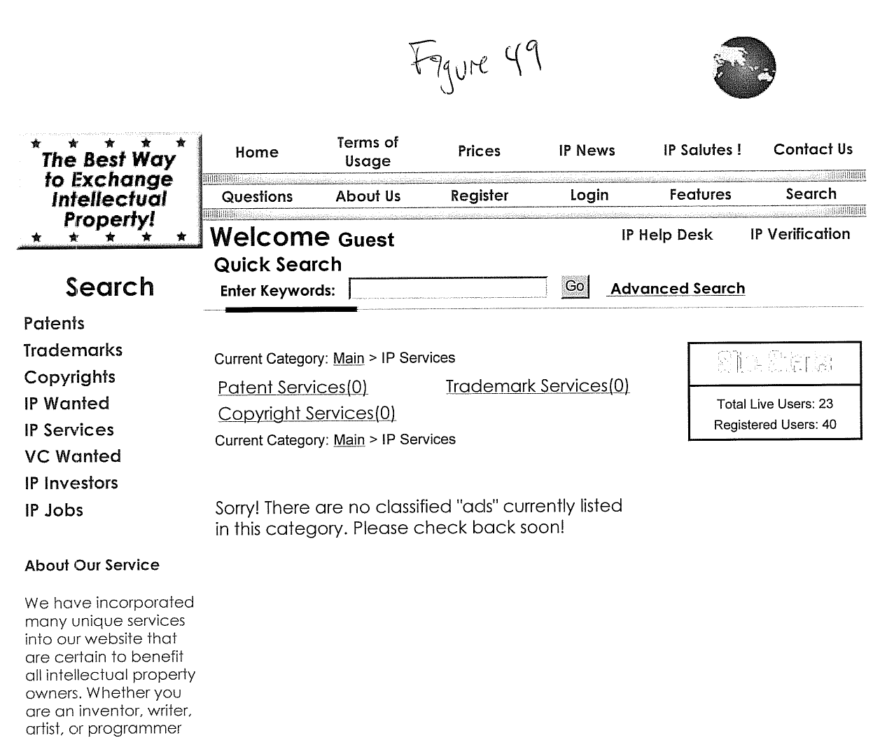

FIG. 50 is a print-out from the inventive website;

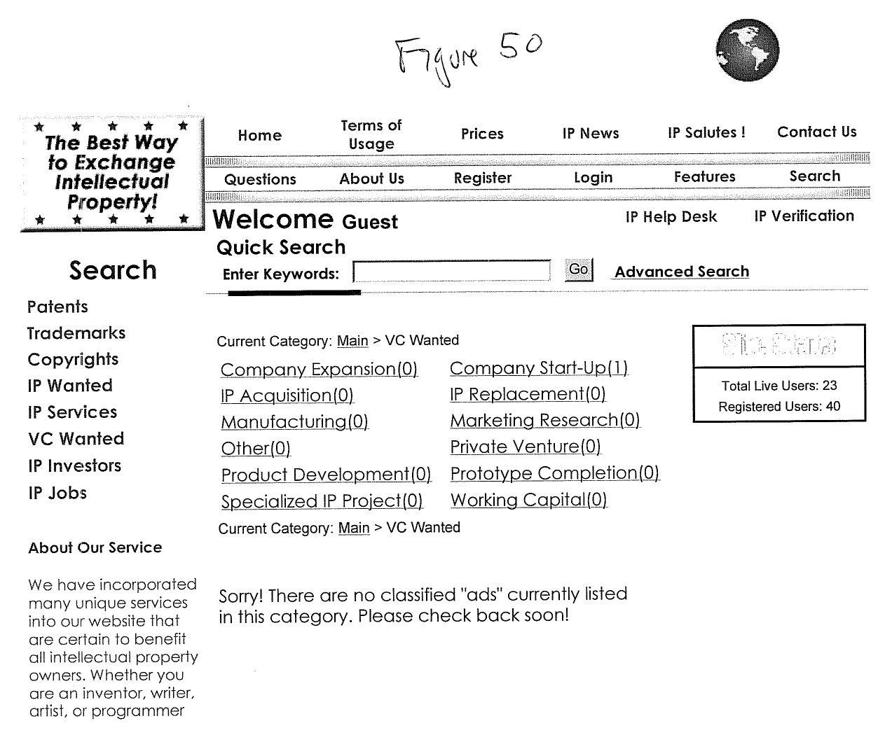

FIG. 51 is a print-out from the inventive website;

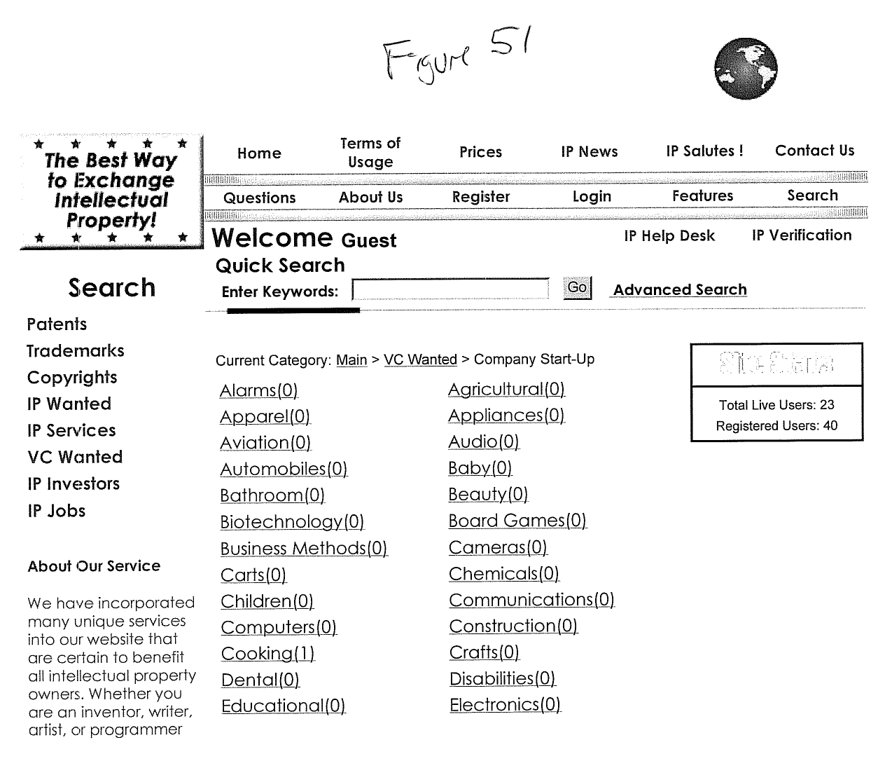

FIG. 52 is a print-out from the inventive website;

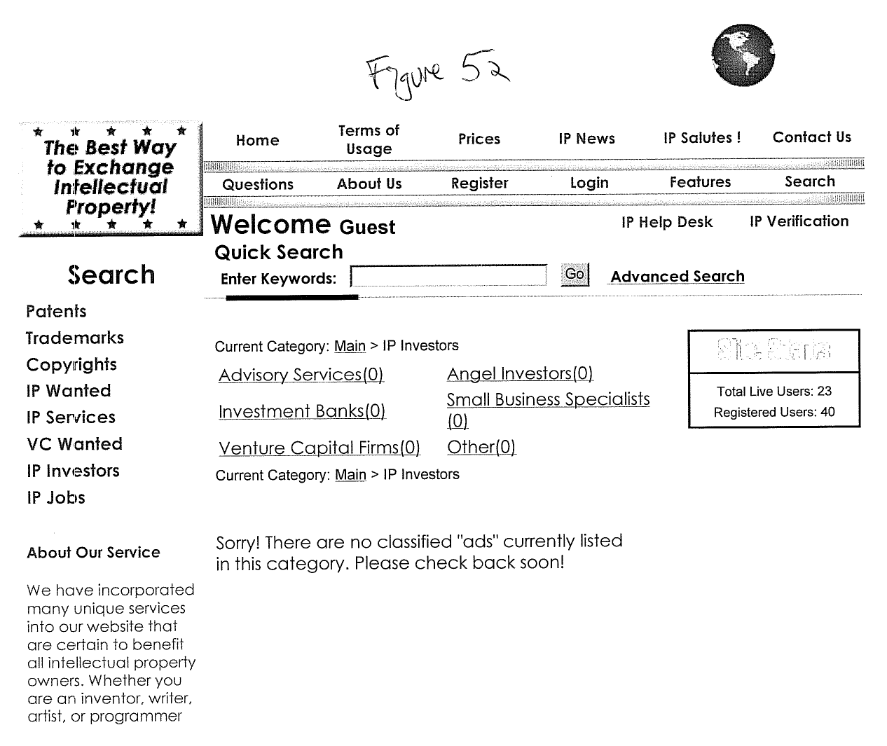

FIG. 53 is a print-out from the inventive website;

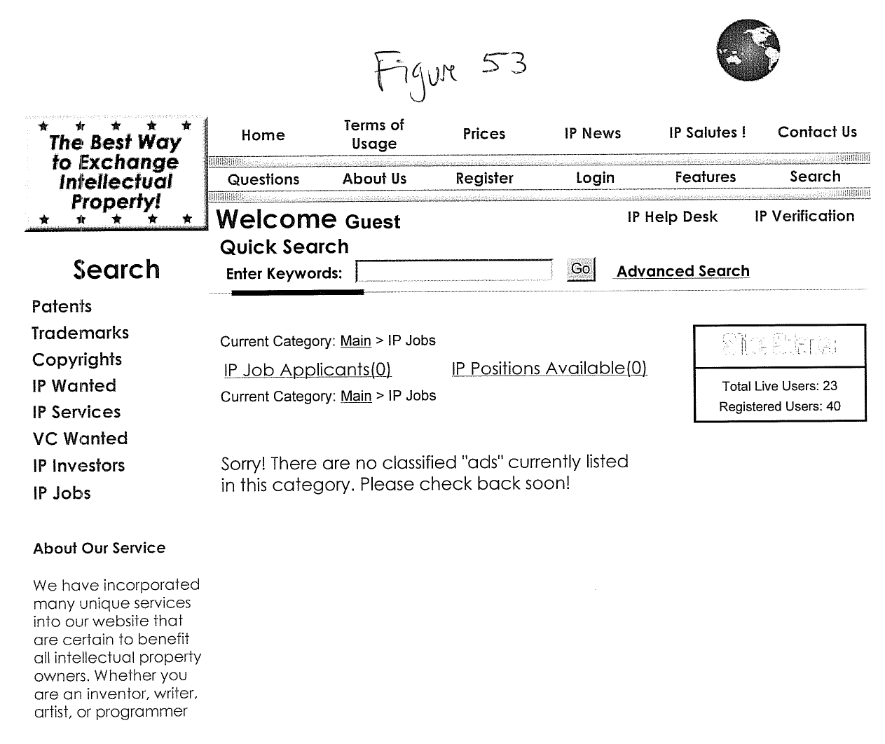

FIG. 54 is a print-out from the inventive website;

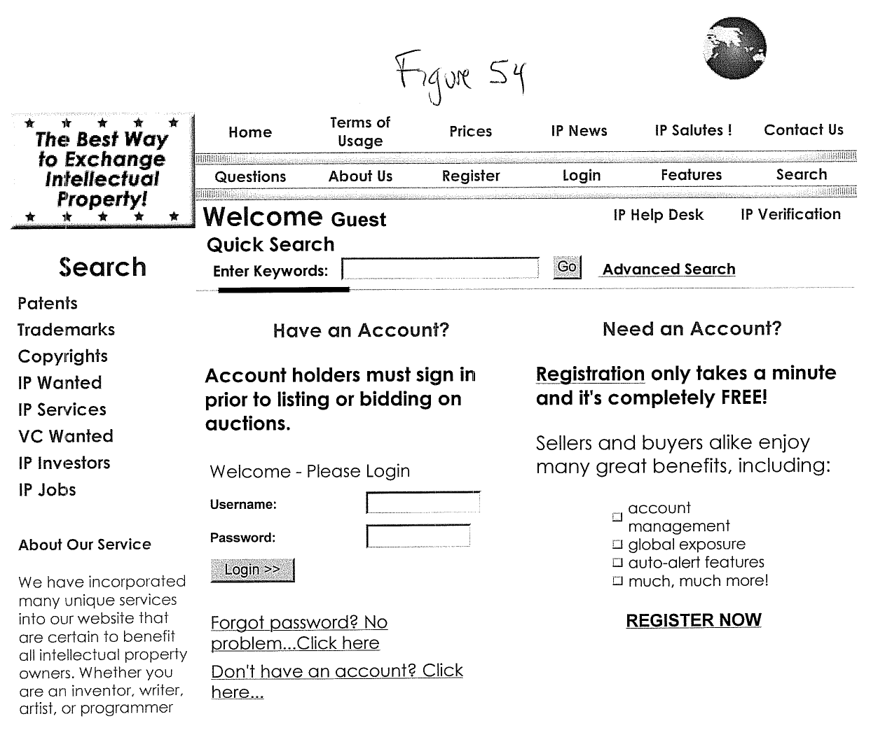

FIG. 55 is a print-out from the inventive website;

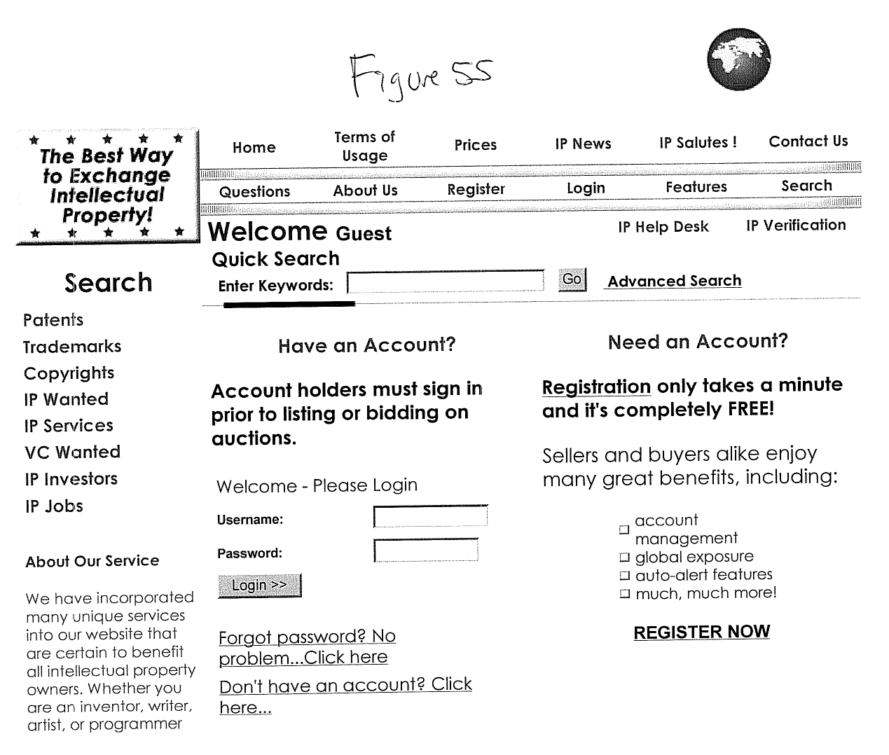

FIG. 56 is a perspective view of the intellectual property exchange building;

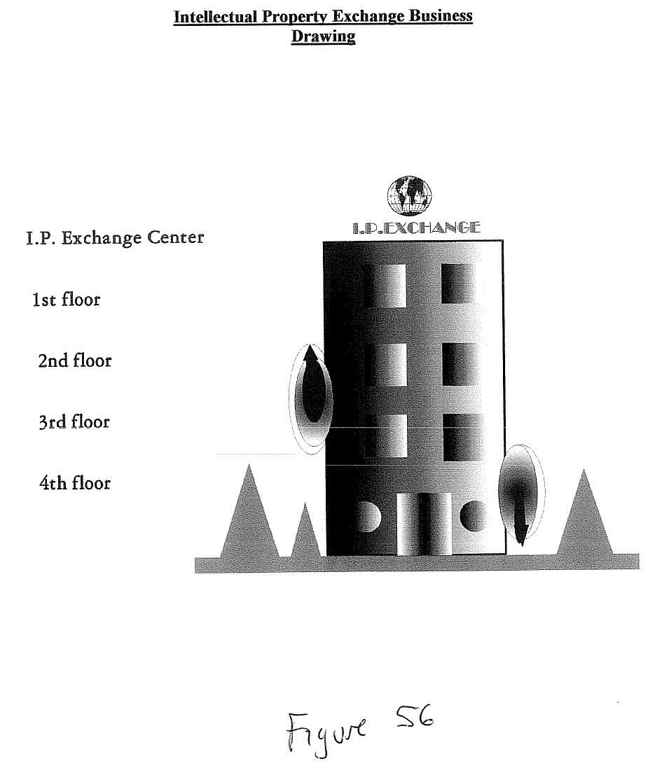

FIG. 57 is a perspective view of the intellectual property exchange building; and,

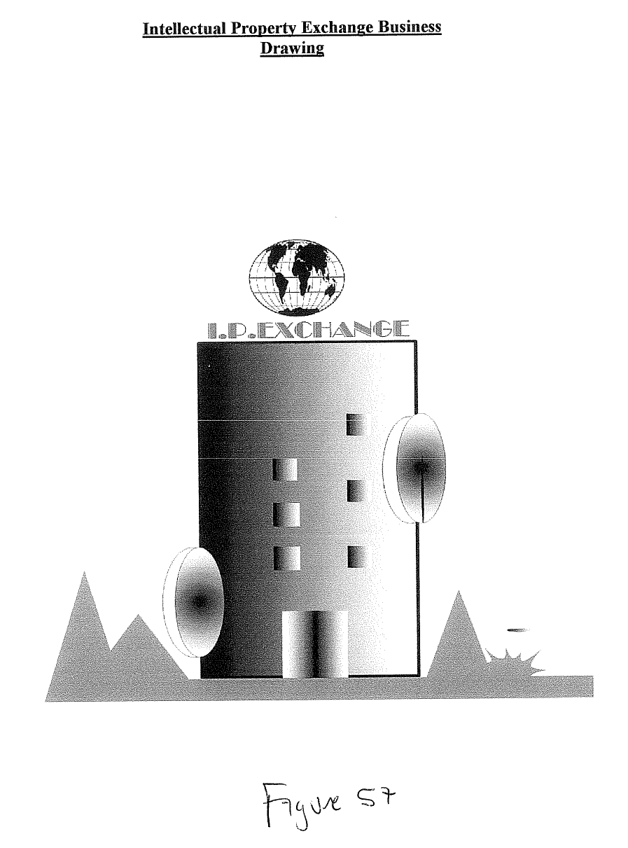

FIG. 58 is a perspective view of the intellectual property exchange building.

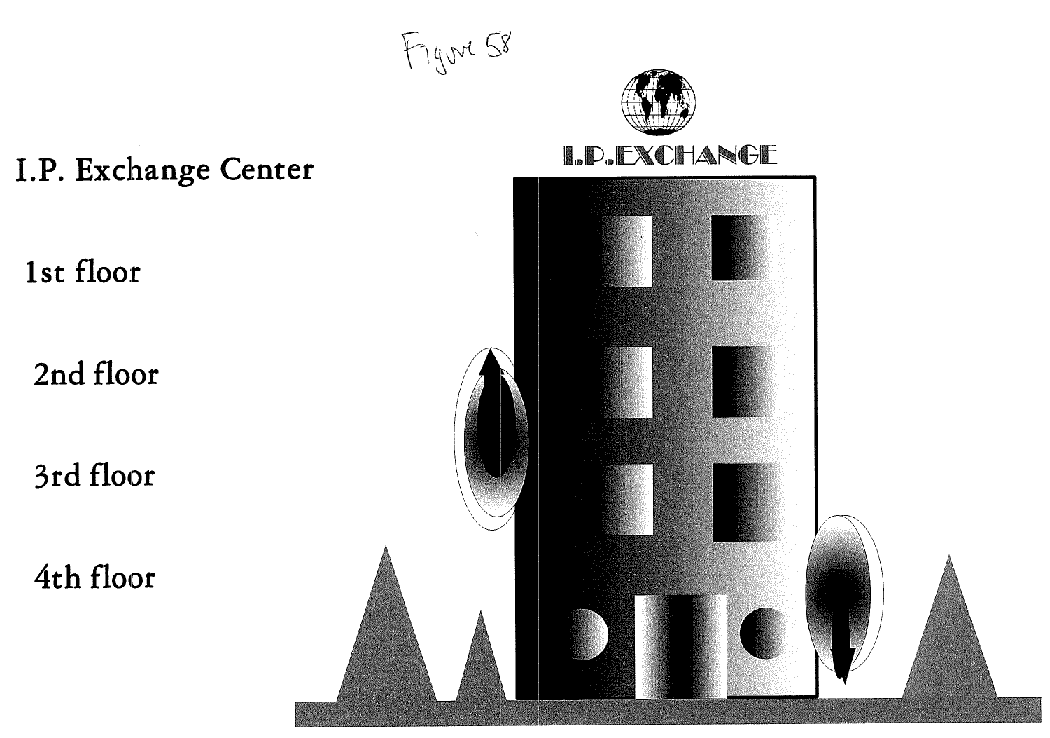

### IV. DESCRIPTION OF THE INVENTION

In one embodiment, the inventive method facilitates cross-licensing arrangements between private inventors, each of whom may need the other inventor's intellectual property rights in order to effectively implement their own invention. This embodiment could also encompass the cross-licensing between companies or between a company and an independent inventor.

In another embodiment, an inventor may have conceived an invention, but does not wish to develop it further, and is interested in cross-assigning his rights to another entity, who is similarly disinterested in pursuing their own invention, but both the first and second inventors are interested in pursuing the other's invention. The process would provide means for such inventors to find projects that interest them and attain rights to those inventions.

The following is an example frequently asked questions from the inventive process:

### Q. How do I Get a Patent, Trademark, or Copyright on my idea?

A. To have an idea legally protected by a patent, trademark, or copyright the first thing that should be done is to contact the Intellectual Property Agency, or Authority established in your territory. The ‘IP Verification’ is a red button located below the main tool bar on our home page and is visible from every page. This button provides a list of direct links to the Internet home pages of Intellectual Property Agencies and Authorities established in various areas of the world. Clicking on the home page of the authority in your territory will enable you to access the appropriate contact information for that particular filing agency. The designated authorities in your area will be able to describe the type of legal protection needed for your particular territory and project, and best direct you toward the type of assistance necessary for your situation.
To have an idea covered by a patent or trademark, you will most likely need to locate a patent agent, or patent attorney to find out exactly how to go about the process. You can locate a professional near you by clicking on our ‘IP Services’ button located on the left side of the home page. You can scroll through the list of IP Service Providers until you make a selection. You should always check with the credentials of the person that you have selected to work with before you decide to give them your business. The links contained in the ‘IP Verification’ can be used to verify if someone is a registered practitioner, in addition to providing the contact information to the filing agency in your area. A quick phone call or e-mail to one of these professionals, or agencies can provide you with some very basic information as to how to begin the legal protection process.

### Back to Top

### How do I place an Intellectual Property Ad?

The first thing that that you must do before placing an ad on the IP-Exchange web site is to register. Registration can be preformed by clicking on the ‘Registration’ button at the top of the home page. Once you have filled out a simple form you will be logged into the system and welcomed. None of the information gathered on this web site is shared with prate or public agencies. If you have already completed the registration process then you must simply login by entering your user name and password. Once you are logged in the menu on the main tool bar on the top of the page will change to accommodate your needs as a registered member. You will then need to click on ‘Place Ad’, and then select the desired category to access the appropriate order form.
The order forms are formatted to help you to structure your ideas quickly, and easily. Again, it is important to remember that you must agree to abide by all rules and regulations that govern this web site by signing a disclaimer, otherwise your ad will be discarded without refund. Next, take your time and fill in your listing information in the fields that the order form provides. Once the text for your order form is complete, you will then need to click the ‘Enter Ad Details’ button that is located at the bottom of the order form. You will then be taken to the ‘Image Collection Page’ where you can enter any photos, or icons that you would like to have appeared in your ad. The system will give you some ‘Editing Options’ that will enable you to correct any mistakes that you may have made during the input process.
Finally, it is important to know that the IP-Exchange is a secured web site, and you can make your payments thought the convenience of Pay Pal. Therefore, simply make the appropriate payment for the time length of the ad that you have selected and click ‘Submit.’ After you have completed these simple steps, your ad will instantly appear on line! For best marketing results, be sure to e-mail the companies in your field and let them know where you ad is displayed.

### Back to Top

### How do I know where to place in my ad?

Strategic planning is always the most important part of any successful formula! Therefore, we suggest that you take a look around The IP-Exchange before placing and ad, especially if this is your first time visiting our web site. The place of primary significance is our ‘Rules & Regulations’ page. This page will give you the guidelines by which to follow when constructing the content for the ad. Once you have reviewed our Rules & Regulations you will also better understand what are considered to be acceptable materials, and practices for each and every listing. Next, you should look at our ‘Prices’ page to select a length of time that best suits your budgeting, and advertising needs.
Before placing your ad, it is also helpful to make note of several useful points. First, you will need to examine the primary search headings, in order to identify which type of intellectual property advertising slot would most suites your specific needs. The primary search headings consist of ‘Patents,’ ‘Trademarks,’ ‘Copyrights,’ ‘IP Wanted,’ ‘IP Services,’ ‘VC Wanted,’ ‘IP Investors,’ and ‘IP Jobs.’ You can find out more about each type of advertisement slot that we offer by reading the information about each type below on this page. Secondly, you may want to look around and make note of what field, or industry specific category that your intellectual property would best is displayed in. Thirdly, it is helpful to scan some of our exiting ads and examine the precise questions in advance that you may want to provide answers to for your own listing. When you feel prepared to place your ad, you must simply click on the appropriate order form that represents the type of ad that you would like to place and begin.

### Back to Top

### What listing information is contained in the ‘Patent’, ‘Trademark’, & ‘Copyright’ Ads?

The ‘Patent,’ ‘Trademark,’ and ‘Copyright’ ads are uniquely designed, single listing advertise slots purchased by intellectual property owners who would like to display their work on-line to a global audience. The IP-Exchange order forms are structured in a way that will enable the seller to secure a buyout, licensing agreement, cross licensing agreement, or even trade their intellectual property. These ads are ideal for any private inventor, development team, company, firm, or anyone else that would like to secure a deal on their existing intellectual property assets.
The main goal of The IP-Exchange is to equip our clients will all of the tools necessary to secure a quick, and simple on-line deal. We pride ourselves on our patent pending business methods and features that help make this possible. As a convenience to you, one of our unique on-line features available in our single listing ads will enable you to display and print an entire legal contract for the intellectual property that you are listing. In addition, by simply placing the desired information into the proper fields on the order form, the exchange system will automatically format ‘Portfolio Services,’ as well as the additional featured services. The single listing IP ads will vary in posting duration dependent upon the length of listing time purchased by the seller.
The single listing intellectual property information that is to be posted must be placed on one, single order form per single Patent, Trademark, or Copyright listing. Any attempt to place more than one issued work on a single application order form will be discarded without refund. For example, if one inventor wants to post two similar inventions that possess different patent numbers, that inventor would need to complete two separate order forms, and purchase two separate ads. Another example would be that if an inventor has a hardware invention that is patented, but that patented invention contains software that is copyrighted, and the inventor would like to sell the patent and copyright separately; the information would be placed on two separate order forms, and charged as two separate ads.
Please note, that it is permissible to include software that is integrated within an invention into a patent deal, however this must be indicated in section E. Transaction Information, by placing notation in the box for ‘Sellers Comments.’ The general rule to follow is one issued work type, (Patent, Trademark, or Copyright) per listing, unless included within the sale of an issued work. The copyright sale of a particular volume, or a series, can be placed on a single ad, but can only be sold separately on separate advertisement listings. If you should have any questions regarding this practice, please feel free to contact us before making a listing decision.

### Back to Top

### What information is contained in the ‘IP Wanted’ Ads?

The ‘IP Wanted’ ads are used for when you, or your company has a need for an IP-based product that is not currently available on our web site. Our highly affordable ‘IP Wanted’ ads enable your company to create and structure your own intellectual property wanted listings that will help then to find the perfect, and absolute latest, industry specific products. The ‘IP Wanted’ ads are designed for locating a specific type of Patented, Trademarked, or Copyrighted work to secure, or invest in. These ads are perfect for businesses that do not have an intellectual property, legal, or product development department, as well as those who do.
By noting the highly detailed, and industry specific requirements necessary to fulfill all of the product needs that you are currently seeking into an ‘IP Wanted’ ad, this ad will help you to locate the ideal concept, product, or designer, needed to help your company succeed. Private inventors, attorneys, artists, authors, and various other intellectual property owners and professionals are given the opportunity to contribute to the innovation process of product development, which is the backbone of a healthy economy. In return, you will save thousands on costly design, development, legal, and travel expenses when purchasing new products from our intellectual property service.
In addition, these ads are great for all highly competitive companies that are seeking to purchase related IP projects, and products off of the market so that they can stay on top. These ads are also great for busy companies, or firms, that need to save time, and money when locating and securing these purchases. Our communication services will enable you, and your company to correspond with the most innovative inventors, and product developers in the industry. Best of all, our ads are affordable for even the smallest businesses. These ads can run consecutively for 1 full year, unless pulled by the subscriber.

### Back to Top

### What listing information is contained in the ‘IP Services’ Ads?

‘IP Services’ ads are advertising slots reserved only for those existing individuals, firms, businesses, or corporations who would like to promote that they are established, and able to contribute to the intellectual property development at any stage of the process. We strongly encourage all IP Professionals and companies to be a part of the listing services that The IP-Exchange offers whether you build prototypes, are an IP Speaker, or assist in royalty negotiations. Please take a moment to review the ‘IP Services’ search categories to help you to decide where you feel that your company, firm, or service would best be displayed. The business ads are a great way to let everyone know that your intellectual property services are readily available. The business ads purchased will appear under the ‘IP Services’ heading only. The ads will then run consecutively for 1 full year, unless pulled by the subscriber.
Please note that if you are a Venture Capital, or a Financial Instruction that would like to advertise with us, please place your ad information under the ‘IP Investors’ category heading. Check out the criteria for the ‘IP Investors’ section as described below. Again, please feel free to contact us prior to placing your listing if you should have any question regarding this practice. As will all of our ads, any attempt to place more than one business ad on a single application order form will be discarded without refund.

### Back to Top

### What listing information is contained in the ‘Venture Capital Wanted’ Ads?

Our ‘Venture Capital’ ads were created for all intellectual property owners who have financial needs based upon their inventions, software development projects, or any other IP project that requires venture capital funding. These ads will help you to better structure and display your financial needs in a way that will let the philanthropist, angel, and corporate investors view your goals so that they know exactly what you are going to accomplish. These ads will professionally display your existing IP work, or works targeted for growth, as well as outline the financial intentions that you have for your particular method of development. These ads are designed to optimize the chances of achieving your plans whether you are seeking funding for start-up seed, expansions, IP Acquisitions, or IP replacement of outdated technology.
Thanks to The IP-Exchanges customized order forms, inventors, developers, and companies finally have a simple and fast way to include others in their intellectual property visions and goals. The ‘Venture Capital Wanted’ order forms will help you to produce interactive and informative ads. These ads are intended to assist you in generating the funding needed for any simple or specialized project such as prototype completion, product development, marketing research, and even private intellectual property ventures. To help ensure your success, you can even enter and display the full text of your business model, and accompanying legal contract. The Venture Capital ads will vary in posting duration dependent upon the length of listing time purchased by the seeker.

### Back to Top

### What listing information is contained in ‘IP Investors’ Ads?

The ‘IP Investors’ ads are specifically reserved for angel investors, venture capital firms, investment banks, venture capital firms, small business specialists, and advisory service providers in additional to any other public or private establishments that are willing to assist inventors and entrepreneurs in the area of funding. These ads enable financially based institutions to showcase their services and increase their number of qualified applicants. To advertise with us, you must be willing to fund an intellectual property based project at any one of its' various stages. When placing an ‘IP Investors’ ad, we ask that you please specify the particular industry fields for which you are willing to fund intellectual property. This will enable the serious industry developers to locate your services far more efficiently. The ads will then run consecutively for 1 full year, unless pulled by the subscriber.

### Back to Top<

### What listing information is contained in the ‘IP Jobs’ Ads?

The ‘IP Jobs’ listings will help you to locate the industry professionals needed to complete any IP project. The ‘IP Jobs’ ads are ideal for when you, or your company has a need for an IP-related service that is not currently available on our web site. These ads are perfect for businesses that do not have an intellectual property, legal, or product development department, as well as those who do. The ‘IP Jobs’ ads are designed for locating an IP based job, or job applicant with very specific qualifications.
Our ‘IP Jobs’ listings will assist you in locating the perfect industry professionals needed for your company, or IP project in a way that is fast and easy. By simply noting the highly detailed, and industry specific requirements necessary to fulfill all of needs that you are currently seeking into an ‘IP Jobs’ ad, this ad will help you to locate the ideal project partner, designer, developer, attorney, or other qualified assistance needed to help your company succeed. Private inventors, attorneys, artists, authors, and various other intellectual property professionals are made aware of the opportunity to collaborate and contribute to the innovation process.
Not only can the ‘IP Jobs’ ads be used when seeking a particular type of job position, or applicant in the IP industry, but they can also be used to locate IP Salesperson, Project Assistance, Project Managers, Project Partners, and even necessary IP Club Officials. The ads are great for all independent inventors that seeking help on a particular project. These ads are also great for busy law firms, or companies that need to save time, and money when seeking the right staff, and HR help for their IP projects. Our communication services will enable you, and your company to correspond with the most innovative professionals in the industry. Best of all, our ads are affordable for even the smallest businesses. These ads can run consecutively for 1 full year, unless pulled by the subscriber.

### Back to Top

### What is the ‘IP Help Desk’?

The ‘IP Help Desk’ is an exclusive, free service provided by The IP-Exchange that enables buyers, and sellers communicate without cost to either of them. The ‘IP Help Desk’ is a chat room designed specifically for those who have products and services displayed on our web site to have a live exchange of valuable information with those who may be interested. Anyone inquiring about the products or services on our web site may use the service. When you locate a product or service of interest, simply check the inside of the ad for the time in which the representative will be available at the ‘IP Help Desk.’ You may then enter the chat room at the times posted to speak with that particular seller, or professional.
The ‘IP Help Desk’ is the ideal place to discuss the problem solving techniques, special features, pricing, and other selling points in greater detail so that a deal can be made. It is also the ideal place to work out last minute contractual kinks, and bartering, making for a smooth IP transition. While you are answering questions at the ‘IP Help Desk’ it just may catch the attention of additional interested parties. This feature often saves sellers the time of having to repeat information. The ‘IP Help Desk’ is available 24 hours a day to everyone interested in intellectual property and therefore can accommodate any schedule. The only requirement for usage is that you complete The IP-Exchange registration form before logging on.

The Intellectual Property Exchange Business is a reputable, pre-established intellectual property networking/trade facility. The facility will serve, as a place to locate or outsource nearly all of the intellectual property needs of the general public, small business, and large corporation. Placing the facility in a centralized location such as in a business district, or in the parking lot of a mall, make the business far more accessible and recognizable to the average consumer than a traditional law firm. Creating a globally recognizable franchise system enables the intellectual property business to become far more economically efficient and can encompass a wider range of clients. The business will act as a processing/trade center for intellectual property sales and purchasing transactions by providing party identification and escrow account services. The business will also provide intellectual property services such as patenting, copyrighting, and trade marking along with assistance with photographing and listing the invention, or service provider, on the associated Internet Website. Additional Intellectual Property Search, Storage, and Management Services can be managed in this particular building, or in similar building having the same uniform franchising colors, codes, and regulatory specifications.
1. The invention relates to intellectual property and all related goods and services in which related operations are preformed in a full service, and unified marketing operation for a fee.
2. When in operation the exchange business facility, and employees, will serve to function as an international ‘Trade Center’ for all intellectual property transactions on all intellectual property related goods and services.
   a. Intellectual property as being defined as all patented, copyrighted, or trademarked materials, goods, trade secrets, and all related documents.
   b. Services as relates to all Intellectual Property Service Providers and Professionals that can provide support, help, or perform a service of any kind and at any stage of the intellectual property process.
   c. A pre-established set of fees are charged for each of the Intellectual Property services and used to operate corporate unit and compensate staff.
   d. The exchange business facility will process transactions, and provide processing location for all parties of transaction requiring payment only on the services rendered directly by the exchange business, or space used within the facility.

### 3. The invention relates to intellectual property that is comprised of one, or multiple yet separate entities operating for business; and of which, all will be legally covered within a unified franchise business system.

a. The Intellectual Property Exchange Business facility may be located in each state in the United States of America
b. The Intellectual Property Exchange Business facility may be located in every country in the world
c. The Intellectual Property Exchange Business facility may be located in every location that honors the United States Patent Cooperation Treaty.
   4. The invention relates to all intellectual property and all related goods and services and that is comprised of particular piece of fixed real estate marked by a facility used to process intellectual property needs, and transactions for a fee to prospective clients and consumers.

### 5. The invention relates to all intellectual property and all related goods and services having a fixed real estate facility designated for the purpose of housing Intellectual Property professionals.

6. The fixed real estate facility will house the various intellectual property professionals for purpose of performing specified business operations, the professionals include but not limited to:
a. Patent Lawyers
b. Patent Agents
c. Search Professionals
d. Listing Agents
e. Copyright Agents
f. Trademark Agents
g. IP Managers
h. IP Litigators
i. Escrow Agents
   7. The invention relates to intellectual property and all related goods and services having a fixed real estate facility, that is not a law firm, but that is used for various intellectual property business operations for all private and public consumers differing by placing a primary focus on processing services and marketing.

### 8. The invention relates to intellectual property and all related goods and services having fixed real estate that is located in a business district, near a mall, near a hotel, or by a major highway.

### 9. The invention relates to intellectual property and all related goods and services having fixed real estate that is designated for the obtainment of patent protection, copyright, trademark protection, and or trade secret protection.

10. The invention relates to intellectual property and all related goods and services having fixed real estate that is designated to provide ‘listing services’ to all peoples, business, and corporate entities for all intellectual property and related goods and services.
11. The invention relates to intellectual property assets having a fixed real estate facility that offers primary listing the ‘Transaction Types’ of ‘sale/buyout,’ ‘license,’ ‘cross license,’ ‘trade,’ ‘exchange,’ or ‘barter’. The exchange business provides education materials to inform public of differences between the various transaction types.

### 12. The invention relates to intellectual property and all related goods and services having fixed real estate that is designated for ‘listing’ Intellectual Property goods and services on an Internet Website.

a. Intellectual Property may be listed for ‘sale,’ ‘license,’ ‘cross license,’ ‘trade,’ ‘exchange,’ or ‘bartered;’ such negotiations/transactions can be conducted at the fixed real estate location, or conducted on the website.
b. A classified intellectual property ‘listing’ may be placed for those seeking a particular type of IP based product, good, or service at the fixed location, or by the direct entering of information by the end user onto the website.
c. One client thereby creating a ‘listing portfolio’ can list multiple pieces of intellectual property such as patents, copyrights, trademarks, and trade secrets.
d. The Internet Website used for listings is works in conjunction with, and is directly related to, the fixed property operating for business in name, principle, corporate entity, governing statutes, transaction processing methods, and/or design.
e. Intellectual Property ‘Listing Application Form’ are made available to clients who wish to have the entire IP listing procedure preformed by the listing agent. This service will result in an additional fee to the client.

### 13. The invention relates to intellectual property having fixed real estate in which space on a particular floor, level, or area is rented out to professionals for a specified fee by the intellectual property exchange business facility.

a. The space is rented to the IP Professionals such as patent attorneys, patent agents, or search specialists for the purpose of conducting Intellectual Property related business services and transactions.
b. A predetermined portion or percentage of each IP related transaction acquired by the persons renting space, and/or operating business with, through, or for the IP Exchange business entity is extracted from each completed transaction and remains within the ownership of the primary business establishment.
   14. The invention relates to intellectual property and all related goods and services having fixed real estate that contains multiple floors within the building, or structure, that has specific floors designated for specific types of IP Professionals, and designated space, or rooms where those specific types of services, and/or transactions are preformed. Practitioners may rent the rooms within the fixed real estate, and therefore contain space for but not limited to:
a. Search Rooms
b. Attorney/Agent Quarters
c. IP Negotiation Rooms
d. IP Managers Quarters
e. Escrow Agent Quarters
f. IP Help Desk
g. IP Listing Stations
h. Photo Room/Booth

### 15. The invention relates to intellectual property and all related goods and services having a fixed real estate facility that contains a designated area with customer counter termed the ‘IP Help Desk’.

a. The ‘IP Help Desk’ is staffed with IP professionals, in particular an ‘IP Listing Agent,’ and remains open to the public at designated times to give information, directions, and guidance on processing various types of IP processes and transactions.
b. The ‘Listing Agent’ that mans the ‘IP Help Desk’ acts as a tour guide by pointing the client to the direction towards instructional and informative literature; or by offering the directions within the facility, or website to the office of the IP Service Provider needed for that particular issue.
c. The ‘IP Help Desk’ on the fixed real estate should consist of a counter or designated area within and near the entrance of the facility.
d. The ‘IP Help Desk’ should remain uniform in color, appearance, and functionality as closely as possible to the ‘IP Help Desk’ on the associated Internet Web Site.
e. The cash register and credit card processing machine used for services transactions preformed within, and by the exchange business facility are located at the ‘IP Help Desk’.
   16. The invention relates to intellectual property and all related goods and services having a fixed real estate facility that is designated to provide an intellectual property ‘Listing Services’ to the public. Professionals employed by the said company establishment perform the service.
f. The intellectual property listing service is provided by a trained ‘Listing Agent’ who enters the intellectual property listing information into the associated Internet System, or assists the client in doing so.
g. The IP Exchange ‘Business Manager’ trains the ‘Listing Agent’ in practical IP and Internet Input techniques, basic IP terminology, along with all associated company rules and regulations.
h. The ‘Listing Agents’ are independently contracted and earn commission wages based upon the number of advertisement listings that they secure for the exchange company.
i. The ‘Listing Agents’ schedule floor time at the ‘IP Help Desk’ located within the exchange business facility. The floor time is unpaid by the company therefore the agent generates income by the listings secured by walk-in's from the public.
j. The ‘Listing Agents’ act as educators to the public by scheduling private consultation services that assist the client in understanding the importance of legal protection.
k. The ‘Listing Agents’ assist the client in locating and selecting an intellectual property professional service provider that is most appropriate for the clients ‘location,’ ‘industry,’ and ‘budget.’ By using ‘in-house company software.
l. When in operation the exchange business facility and employees will serve to function as an international ‘Trade Center’ for all intellectual property transactions for all intellectual property related goods and services by acting as a fixed, and objective third party entity.
m. The client may choose to establish the ‘trade/exchange center’ as a fixed entity location for the use sending official patent documents, copyright, trademark, and trade secret documents thereby providing anonymity and security to the client and protection during the IP transaction process.
n. The ‘Listing Agents’ makes regular contact via telephone/e-mail to inform clients that their IP has been successfully processed, and that their IP registration number has been received by the exchange business facility.
o. The ‘Listing Agent’ informs the client when their patent paperwork and file numbers are received by the facility, in order that the client can come into the facility for assistance with listing, or list from home pc.
p. The ‘Listing Agent takes’ digital photographs of prototypes, clients, and IP Service Professionals for a fee, to be placed on the electron classified ad on the associated Internet Web Site. This service can be preformed at the exchange facility or on client location.
q. The ‘Listing Agent’ works only from a lap top computer that they own and that must have present on all appointments with clients.
r. The ‘Listing Agent’ takes digital photographs of clients form all participating parties in order to create a Membership Card.
s. The ‘Listing Agent’ is responsible for entering new members into the Membership Database used for discounts and promotions.
t. The ‘Listing Agent’ takes digital photographs and product videos for the marketing of the client intellectual property or service. This task is done so at the exchange facility or at the client location.
u. The ‘Listing Agents’ are appointed to specific industrial areas based upon educational background and related qualifications.
   17. The invention relates to intellectual property and all related goods and services having a fixed real estate facility that is designated to house intellectual property service providers and operational managers such as:
a. IP Exchange Business Manager
b. Intellectual Property Listing Agent
c. Intellectual Property Escrow Agent
   18. The IP Exchange ‘Business Manager’ is responsible for:
a. The ‘Business Manager’ oversees employees, hires, trains, schedules, fires, and ensures that all ‘Professional Suites’ are rented at all times within the IP Exchange Business facility.
b. The IP Exchange ‘Business Manager’ recruits listing agents schedules, all employees and encourages sales calls and productivity within the business facility.
c. The IP Exchange ‘Business Manager’ assists costumers at the ‘IP Help Desk’ when needed.
d. The IP Exchange ‘Business Manager’ solicits and encodes new IP Exchange Discount and Promotional Membership Clients into the computer.
e. The IP Exchange ‘Business Manger’ schedules and conducts live computer demonstrations of the company scope and functionality of the associated Internet Web Site, or assigns listing agent to do so, for all area Patent Clubs, Shows, Seminars and Special Requests for Schools, Universities, Small Business, and Companies.
   19. The invention relates to intellectual property and all related goods and services having fixed real estate that contains multiple floors within the building, or structure. The main entrance, or floor, of which contains several computer terminals, or stations that consist of a desk or counter, chairs, computer, monitor, and scanner are termed ‘listing stations.’
a. The computer located at each ‘listing station’ continually displays the associated Exchange Internet Web Site.
b. The computer is for client/public use in accessing ‘Intellectual Property Verification’ sites and tools that have been pre designated by the IP Exchange Business Staff as well as any additional regulated intellectual property information contained on the associated Internet Web Site only.
c. The computer is for client/public use for listing Intellectual Property in the form of manually placing classified ad information and accompanying photos of clients, prototypes, product demos and business facilities onto the associated Internet Web Site only.
   20. The invention relates to intellectual property and all related goods and services having fixed real estate that contains multiple floors within the building, or structure. The main entrance, or floor, of which has a segregated area used for taking digital photos and creating product demonstrational videos.
a. The digital photos and/or videos are taken by the Listing Agent and are of the clients that wish to list their intellectual property, or IP services on the associated Internet Web Site.
b. The digital photos and/or videos are taken by the Listing Agent and are of the prototype of a particular invention, gadget, or technology that is to be listed on the associated Internet Web Site.
c. Clients are able to make product videos from their home pc and download them to the ip exchange Internet website.
d. The digital and video equipment is owned by the exchange facility location and is stored in the ‘IP Photo Room’
   21. The invention relates to intellectual property and all related goods and services having a fixed real estate facility that contains multiple floors within the building, or structure. The main entrance, or floor, of which has a segregated area contains within its structure rooms specifically designated for;
a. The ‘IP Help Desk’
b. The ‘IP Listing Stations’
c. The ‘IP Photo Room’
d. The ‘IP Photo Room’ is an area used for taking digital photos. And creating product videos for the client.
   22. The invention relates to intellectual property and all related goods and services having fixed real estate that of which is open to the general public. The entrance of the facility having shelving for the specific purpose of displaying brochures, instructional manuals, trade magazines, and other informative literature to the general public.
a. The literature will explain the IP Exchange services, facilities, associated website, methods to search, how to obtain a patent, copyright, trademark, and other educational and instructive information in addition to transaction and processing terminology and procedures preformed by the exchange facility.

### 23. The invention relates to intellectual property and all related goods and services having a computer database system that conjoins each separate entity for the purpose of logging and maintaining a Club/Membership System.

a. The Club/Membership System may or may not be implemented.
b. Club/Membership System is used to track participants of specific promotional, discount, or giveaway packages.
c. The facility will issue Club/Membership System identification cards to participating members for identification and benefit redemption purposes.
d. The Club/Membership System is geared towards Law Firms, Universities, Small Business, Private Inventors, and anyone that may be interested in obtain discounted services from the particular intellectual property facility.
e. The Club/Membership System consists of different levels of discounted services and is sold to prospective clients based upon monetary spending habits and services most frequently used.
f. The computers will be used to locate a business exchange facility, or listing agent in the desired area.

### 24. The invention relates to intellectual property and all related goods and services having fixed real estate that houses a professional staff of employees who provide intellectual property related services to the public.

a. The employees must wear matching uniforms that are consistent in color and style with the business logo, facility, decor, and associated web site.
b. The only employees that may be exempt from uniforms are the patent agent, and attorneys.
c. All services rendered by the employees, and all associated prices, are pre-established by the IP Exchange Business Management, Board of Directors, or Corporate Entity.

### 25. The invention relates to intellectual property and all related goods and services having fixed real estate that houses intellectual property professionals in particular an ‘Intellectual Property Escrow Agent’.

a. The ‘IP Escrow Agent’ is an Intellectual Property Exchange Business employee who assists in the intellectual property transfer and assignment process for buyers and sellers by acting as unbiased third party.
b. The ‘IP Escrow Agent’ is responsible for the proper identification of each party involved in a particular intellectual property transaction.
c. The ‘IP Escrow Agent’ is responsible for obtaining the signatures of each party involved in an intellectual property transaction.
d. The ‘IP Escrow Agent’ is responsible for accessing, processing, and filing all necessary paperwork involved in an intellectual property/technology transfer transaction, then alerts the agent/attorney to begin proper filing of documents at the United States Patent Office for all IP assignments, licensing, and ownership transactions.
e. Upon receipt of earnest money made by a first party involved in a transaction, the ‘IP Escrow Agent’ is responsible for accessing the electronic account of the seller by entering a numerical pin code, then encode monetary amount into the ‘Exchange Computer System’.
f. The updated payment status made by the first party will then appear in the end user/send party's ‘Account Management System ’ as information pertaining to the ‘Transactions’ on the owners account.
   26. The invention relates to intellectual property and all related goods and services having fixed real estate that houses intellectual property professionals and that is used by the public as an third party ‘Escrow Agency’ for intellectual property and technology transfer.
a. A complete Intellectual Property-Processing Center that is comprised of a fixed real estate facility that works in conjunction with a computer system assessable to every sector of society including but not limited to private inventors, small business, large corporations, universities, law firms, and all IP Service Professionals and is established for the purpose of exchanging intellectual property business transactions.
b. The buyer can leave a monetary amount in the form of cash or check with the staff at the business facility that will properly identify, process, and hold the amount in the established escrow services account for a fee.
c. The escrow payment fee is the financial responsibility of the party stated in the written agreement made between the buyer and the seller.
d. The ‘IP Escrow Agent’ can access the details of each of the escrow accounts, and the accompanying transaction intentions on the ‘Exchange Computer System’.
e. The ‘Escrow Agent’ logs the details of the intellectual property deal or agreement in addition to the amount that is placed with escrow into the computer.
f. The Escrow Accounts can be accessed by clients by logging on to the associated Internet website and entering the proper membership identification number and password for which they will then gain access to their own ‘Account Management System.’
g. Interested party may make an escrow deposit at the exchange business facility that will appear on the sellers pc accessed by his ‘Account Management System.’

### 27. The invention relates to intellectual property and all related goods and services having fixed real estate that houses intellectual property professionals such as ‘IP Searchers.’

a. The number of patent searches retrieved is based upon client needs and price willing to pay.
b. The documents retrieved from and intellectual property search can be picked up or delivered on client location by the IP Exchange Business staff.

### 28. The fixed real estate facility will display the exchange business information in electronic format on the wall of the first floor of the facility.

a. The exchange information will be in the format of an electronically fixed code comprised of information that directly correlates to the categorical heading/tagging, information located on the Exchange Internet Website.
b. The exchange information will be in the format of an electronically fixed code comprised of information that displays Trading information for all Patents, Copyrights, and Trademarks.
c. The exchange information will be in the format of an electronically fixed code comprised of information that displays primary industrial subcategory information that is located on the Exchange Internet Website.
d. The exchange information will be in the format of an electronically fixed code comprised of information that displays trading statistics on activity that occurs through the exchange business by identifying the type of intellectual property transaction such as ‘buyout,’ ‘license,’ ‘cross-license,’ ‘trade,’ or ‘investment’.

### The electronic code provides up to date trading activity on a continuous basis.

The invention has been described with reference to several embodiments.

Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. An apparatus for providing at least one transaction of intellectual property rights, the method comprising the steps of:
providing a means for listing intellectual property rights;
providing means for accessing the means for listing;
providing a searchable database of the intellectual property rights; and,
categorizing the intellectual property into technology categories.
